(19) United States
(12) Patent Application Publication
(10) Pub. No.: US 2013/0211944 A1
(43) Pub. Date: Aug. 15, 2013

(54) SYSTEM, METHOD AND COMPUTER PROGRAM PRODUCT FOR SHARING A PRODUCT/SERVICE AND ITS ASSOCIATED PURCHASE PRICE BETWEEN CUSTOMERS

(71) Applicants: Zulfiqar N. Momin, Austin, TX (US); Ahmed Moledina, Austin, TX (US)

(72) Inventors: Zulfiqar N. Momin, Austin, TX (US); Ahmed Moledina, Austin, TX (US)

(21) Appl. No.: 13/882,482

(22) PCT Filed: Oct. 5, 2011
(86) PCT No.: PCT/US2011/054940

§ 371 Date: Apr. 29, 2013

Related U.S. Application Data
(60) Provisional application No. 61/408,754, filed on Nov. 1, 2010.

(51) Int. Cl. G06Q 30/06

(52) U.S. Cl. CPC G06Q 30/0605
USPC 705/26.2

(57) ABSTRACT

A peer-to-peer, collaborative, group-buying website permits customers co-pay and co-share items. The e-commerce website may locate and display an item offered for sale by a merchant. A sale price of the item may be displayed wherein use and sale price of the item may be shared between first and second customers. A first customer bid may be displayed to use the item for a first period of time wherein the first bid is equal to a first fraction of the sale price. A second customer bid may be displayed to use the item for a second period of time wherein the second bid is equal to a second fraction of the sale price. In this manner, the first and second customers are authorized to use the item for the first and second periods of time upon simultaneously paying the first and second fractions of the sale price.

### CROSS REFERENCE TO RELATED APPLICATIONS

This application is a U.S. National Stage Application claiming the benefit and priority of PCT International Application No. PCT/US2011/54940, filed Oct. 5, 2011, which claims the benefit of U.S. Provisional Application No. 61/408,754, filed Nov. 1, 2010, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF EXEMPLARY EMBODIMENT(S) OF THE PRESENT DISCLOSURE

1. Technical Field

Non-limiting exemplary embodiment(s) of the present disclosure generally relate to e-commerce systems and methods and, more particularly, to an online purchasing system, method and/or computer program product for providing an easy and convenient means of sharing a product and its associated purchase price between customers.

2. Prior Art

E-commerce typically includes the buying and selling of products or services over the Internet and dedicated computer networks. The amount of trade conducted electronically has grown extraordinarily with widespread Internet usage. E-commerce has spurred innovations in electronic funds transfer, supply chain management, Internet marketing, online transaction processing, electronic data interchange (EDI), inventory management systems, and automated data collection systems, just to name a few. Most e-commerce involves the purchase of services and/or physical items in some way. Today, many retailers have an online retail division in addition to their physical stores. Some retailers such as AMAZON®.com provide shopping for their customers directly online via the internet only. The sale and purchase transaction is completed electronically and interactively in real-time. Others such as EBAY®.com provide an intermediary service for clients' sale and purchase transactions.

E-commerce has led to intensified price competition by increasing consumers' ability to gather information about products and prices. In spite of these advantages, purchases are still being made in a rather conventional way of buyer-seller transactions whereby a product is sold using a single transaction to a single purchaser only. In the event that purchasers require a new product for a short period of time, they have to purchase a new expensive one and resell at a considerable loss. In many cases, they may not even be able to sell the used product. For cost-conscious consumers, they too find it difficult to purchase a used product that is within their budget and reliability expectations.

Accordingly, a need remains for a system, method and computer program product that overcomes the above-noted shortcomings. Exemplary embodiment(s) of the present disclosure satisfy such a need by providing an online purchasing system and method that is convenient and easy to use, versatile in its applications, and designed for sharing an item and its associated purchase price between customers.

### BRIEF SUMMARY OF THE PRESENT DISCLOSURE

In view of the foregoing background, it is therefore an object of exemplary embodiment(s) of the present disclosure to provide an online purchasing system, method and/or computer program product for providing an easy and convenient means of sharing a product and its associated purchase price between customers. It is noted that the term “product”, “service” and “item” may be interchangeably used throughout this disclosure. The product may be embodied in a physical (tangible) form and/or may be embodied in an electronic format that is transmitted via an electronic communication link, i.e., e-books, e-games, e-tickets, etc. that may be accessed online or via a portable electronic display such as a KINDLE®, IPAD®, NOOK® and/or laptop, for example.

These and other objects, features, and advantages of exemplary embodiment(s) of the present disclosure are provided by a method of sharing a product's purchase price between collaborating customers. As a non-limiting example, customers A and B desire the same product wherein customer A has an immediate need to use the product (e.g. video game) and customer B can wait for a first agreed time period (30 days) before receiving the product. Each customer pays a fraction of the product price, e.g. 40% and 60%, respectively. Customer A immediately receives and uses the new product for the pre-agreed time period and then sends the product to customer B. Thus, customer A temporarily uses the product at 40% of the product price while customer B receives the product after 30 days. Customer B may own the product indefinitely thereafter or return it after a second agreed time period (45 days). In such an example, customer A does not own the product and is only a one time user, while customer B may also be a onetime user or a permanent owner of the product.

Notably, a non-limiting exemplary embodiment(s) of the present disclosure enables value-conscious customers (bargain hunters) to obtain a bottom-line “customer savings.” The on-line web-enabled platform (user interface) may be monitored via a third party service provider that enables customers to share the purchase price/use of the item according to each customer's desire to either temporarily use the product or permanently own the product, respectively.

In a non-limiting exemplary embodiment(s) of the present disclosure, the system may be an e-commerce website system for sharing an item's purchase price/use between customers (buyers). Customers and merchants (sellers) may register online to the e-commerce website's network by signing up for an account to pay for shared transactions. Customers may bid to share a product through a fixed or variable rate. An example of a shared bid could be a 40/60 percent ratio on payment. Each customer may pay a percentage based on whether he/she permanently receives the item or merely uses the item for specified period of time, for example. Payment through the e-commerce website is preferably simultaneous so that the seller receives full payment before customers A or B receive the purchased item from the seller.

In a non-limiting exemplary embodiment, the shared item may be any type of physical/electronic merchandise from any type of retailer, distributer, wholesaler, merchant, etc. that is within the e-commerce website network; (i.e. ranging from registered individuals to registered retail businesses). In a non-limiting exemplary embodiment, an outside retailer such as BESTBUY® may sell their product and receive their payment in accordance with the business method functions of the present disclosure. Such a retailer may be a merchant as defined in the present disclosure. In this manner, a DOBA® server (described herein below) of the e-commerce website may keep track of the retailer's or distributer's items via an application program interface (API). Thus, the e-commerce website may or may not keep track of a particular retailer/distributor's inventory. Rather, DOBA® identifies a source of the purchased item and communicates the sale of that item directly to the retailer/distributor thereby enabling the retailer to sell their product/service and receive their payment in accordance with the collaborative cost/use sharing business method functions of the present disclosure. Once the item is released to the customers, the merchant may be no longer involved.

As an example, for a lesser percentage of the purchase price, customer A receives the product from the merchant for a first period of time (i.e. thirty days). Customer A, after using the product for thirty days, then sends the item to Customer B. Customer B receives the item from Customer A at which time customer B uses the product for a second period of time. Customer B may now be the permanent owner of the item or may use it for the second period of time and thereafter return it to customer A. Both customers A and B may sell the item collectively as a group to a new customer C, and proceeds from the latest sale may be proportionally credited to customer A and B's account, respectively. Of course, this process may be repeated numerous times such that the item is sold numerous times to multiple customers during the item's useful life.

In a non-limiting exemplary embodiment(s) of the present disclosure, a merchant may provide an item for purchase between two friends on the e-commerce website network who after receiving the item for a specified period of time, each friend sells the item back to another customer. In this manner, customers A and B can become merchants to subsequent customers or even a group of customers (customer C and D) in the e-commerce website network.

In a non-limiting exemplary embodiment(s) of the present disclosure, different customers or groups of customers may have a product (i.e. game) to exchange with each other. Take for example, customers A & B's game hypothetically is worth $40 and customers C & D's game is worth $60. In this case, customers A & B will pay $20 over and above the cost of their game to customers C & D. Customers A & B's friends will proportionally pay the cost 40% and 60% or other variable cost mutually agreed upon between customers. Customers A & B's credit card may be charged and customers C & D's account may receive the credit proportionally. Of course, a variety of conventional financial payment types may be employed such as payment from a customer's bank account, debit account, PAYPAL® account, etc., without departing from the true spirit and scope of the present invention.

In a non-limiting exemplary embodiment(s) of the present disclosure, multiple customers on the e-commerce website network can exchange an item with each other such that a peer-to-peer exchanging of the item is achieved. Customers A & B may be friends who want to purchase a product (e.g. game) from a merchant. They may intend to sell the game after each customer has used the product for an agreed period of time (30 days). Both customers A & B mutually agree to pay either a variable or fixed price of 40% and 60%, respectively. Customer A receives the item first then sends it to customer B. After both customers have used the product for the agreed time period, such customers will sell the item (become merchants) to a subsequent customer C. The proceeds from the sale are proportionally credited to customer A and B; i.e. 40% and 60%, respectively. Thus, exemplary embodiment(s) of the present disclosure disclose co-sharing, co-paying, and co-selling an item to subsequent customers so that the current customers receive proportional cash and/or credit to further minimize the cost of the game to the current customers. This process may be repeated over the useful life of the item.

In a non-limiting exemplary embodiment(s) of the present disclosure, a merchant, customers (resellers) and/or the e-commerce website service provider may provide real-time coupon(s) for facilitating the purchase/sale of items displayed on the e-commerce website. For example, two customers may be willing to purchase a textbook from a merchant. Customer A is willing to pay 60% and customer B wants to buy it as well but not at the remaining 40% to complete the transaction. In this case, a merchant may provide an incentive to customer B; such as sending a real-time coupon to customer B for 10% off. Such a coupon would provide customer B a reduction in the remaining 40% owed for the product and thereby encourage customer B to complete the transaction. Thus, offering a coupon in real-time may entice hesitant customers to collaborate with willing customers and thereby complete the co-purchase/co-use of the item. Of course, such coupons may be applied to customer groups as well wherein each customer group receives a discount proportional to their co-sharing percentages within their specific group.

In a non-limiting exemplary embodiment(s) of the present disclosure, the e-commerce website service provider may offer group buying opportunities for an item, and thereby enable the group to receive greater discounts on the item. Such group buying may require a minimum number of customer purchases or the deal is null and void for everyone. For example, if 2,500 customers participate in sharing the use/price of the item, the e-commerce website service provider may offer to the group a 75% discount off the merchant's asking price. In this manner, numerous customer pairs belonging to the group may co-buy/co-share numerous units of the item. Such group buying would be implemented as a co-paying and co-sharing basis, where customers can form large groups to bring down the cost of the item on a co-pay basis and/or meet the merchant's requirements to complete the purchase/sale transaction.

In a non-limiting exemplary embodiment(s) of the present disclosure, a merchant may offer services as well. Conventional hotel booking websites do not permit multiple customers to collaborate and share the use/cost of a hotel room. In particular, a single customer may be required to book a hotel room for a minimum number of days, such as a week. The present disclosure overcomes such a shortcoming wherein multiple customers may collaborate together and purchase a hotel room for an extended period of time and thereby share the use of the hotel room as needed. For example, two customers in need of hotel room during different time frames can collaborate together and reduce their individual costs for booking the hotel room. In particular, if customer A needs the hotel room from Saturday to Sunday (two days), and customer B needs the hotel room from Monday to Friday, such customers can collaborate to book the hotel room for an entire week instead of separately booking the hotel room. Two or more customers may simultaneously book the same hotel room and agree to share the use of the hotel room in a manner that is commensurate or proportional to the amount of money they wish to spend. Such a co-share and co-pay arrangement will increase the hotels occupancy rate while reducing each customer's individual costs.

In a non-limiting exemplary embodiment(s) of the present disclosure, at the time of a transaction, customers A and B pay 40% & 60%, respectively, for the item purchased. Each customer's credit card on file may be pre-authorized for a total purchase price of the item in case each customer damages the item while in possession of the item. Once the item is shipped to the subsequent customer, the previous customer may be absolved of damage liability. Alternately, the previous customer's liability may continue until the subsequent customer receives the item. In this manner, either upon customer A sending the item in good condition or upon customer B receiving the item in good condition, customer A's deposit will be released.

In a non-limiting exemplary embodiment(s) of the present disclosure, it is an object of the present invention to provide a method of conducting a real-time co-pay and co-share bidding process that permits individual bidders (customers) to pool (share) their bids for a desired item. It is another object of the invention to greatly increase the number of participants in the real-time bidding process by permitting individual bidders to form co-buying and co-sharing groups. It is a further object of the invention to display updated co-pay and co-sharing bid information for bidders to view in real-time.

There has thus been outlined, rather broadly, the more important features of exemplary embodiment(s) of the present disclosure in order that the detailed description thereof that follows may be better understood, and in order that the present contribution to the art may be better appreciated. There are additional features of exemplary embodiment(s) of the present disclosure that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define exemplary embodiment(s) of the present disclosure of the application, which is measured by the claims, nor is it intended to be limiting as to the scope of exemplary embodiment(s) of the present disclosure in any way.

### BRIEF DESCRIPTION OF THE SEVERAL VIEWS OF THE DRAWING

The novel features believed to be characteristic of exemplary embodiment(s) of the present disclosure are set forth with particularity in the appended claims. Exemplary embodiment(s) of the present disclosure itself, however, both as to its organization and method of operation, together with further objects and advantages thereof, may best be understood by reference to the following description taken in connection with the accompanying drawings in which:

FIG. 1 a high-level schematic diagram illustrating the interrelationship between the major components of exemplary embodiment(s) of the present disclosure;

FIGS. 2a-2c are flow charts illustrating a non-limiting exemplary embodiment of the e-commerce website's functionality;

FIG. 3 is a high-level diagram illustrating a general process of exemplary embodiments of the present disclosure; and

FIGS. 4-42 are sample screen shots taken from a non-limiting exemplary embodiment of the e-commerce website employing the functionality of the present disclosure.

Those skilled in the art will appreciate that the figures are not intended to be drawn to any particular scale; nor are the figures intended to illustrate every embodiment(s) of the present disclosure. The present disclosure is not limited to the exemplary embodiment(s) depicted in the figures or the shapes, relative sizes or proportions shown in the figures. In fact, some of the screen shots may be truncated to satisfy margin and font requirements.

### DETAILED DESCRIPTION OF EXEMPLARY EMBODIMENT(S) OF THE PRESENT DISCLOSURE

Non-limiting exemplary embodiment(s) of the present disclosure will now be described more fully hereinafter with reference to the accompanying drawings, in which at least a preferred embodiment of exemplary embodiment(s) of the present disclosure is shown. The method, system and/or computer program product of the present disclosure may, however, be embodied in many different forms and should not be construed as limited to the exemplary embodiment(s) set forth herein. Rather, such embodiment(s) is/are provided so that this application will be thorough and complete, and will fully convey the true scope of exemplary embodiment(s) of the present disclosure to those skilled in the art. Like numbers refer to like elements throughout the figures.

The illustrations of the embodiment(s) described herein are intended to provide a general understanding of the structure, method and functionality of the various embodiment(s). The illustrations are not intended to serve as a complete description of all of the elements and features of method(s) and/or system(s) that perform the functions described herein. Other embodiment(s) may be apparent to those of skill in the art upon reviewing the disclosure. Other embodiment(s) may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “exemplary embodiment(s) of the present disclosure” merely for convenience and without intending to voluntarily limit the scope of this application to any particular invention or inventive concept. Moreover, although specific embodiment(s) have been illustrated and described herein, it should be appreciated that any subsequent arrangement designed to achieve the same or similar purpose may be substituted for the specific exemplary embodiment(s) shown. This disclosure is intended to cover any and all subsequent adaptations or variations of various embodiment(s). Combinations of the disclosed embodiment(s), and other embodiment(s) not specifically described herein, will be apparent to those of skill in the art upon reviewing the written description, figures and/or claims.

The Abstract of the Disclosure is provided to comply with 37 C.F.R. §1.72(b) and is submitted with the understanding that it will not be used to interpret or limit the scope or meaning of the claims. In addition, in the foregoing detailed description, various features may be grouped together or described in a single embodiment for the purpose of streamlining the disclosure. This disclosure is not to be interpreted as reflecting an intention that the claimed embodiment(s) require more features than are expressly recited in each claim. Rather, as the following claims reflect, inventive subject matter may be directed to less than all of the features of any of the disclosed embodiment(s). Thus, the claims are incorporated into the detailed description, with each claim standing on its own as defining separately claimed subject matter.

Furthermore, exemplary embodiment(s) of the present disclosure may be described herein in terms of functional block components, screen shots, optional selections and various processing steps. It should be appreciated that such functional blocks may be realized by any number of hardware and/or software components configured to perform the specified functions. For example, the exemplary embodiment(s) of the present disclosure may employ various integrated circuit components, e.g., memory elements, processing elements, logic elements, look-up tables (databases), and the like, which may carry out a variety of functions under the control of one or more microprocessors or other control devices. Similarly, the software elements of the exemplary embodiment(s) of the present disclosure may be implemented with a variety of programming or scripting language such as C, C++, Java, COBOL, assembler, PERL, extensible Markup Language (XML), with the various algorithms being implemented with any combination of data structures, objects, processes, routines or other programming elements. Further, it should be noted that the exemplary embodiment(s) of the present disclosure may employ any number of conventional techniques for data transmission, signaling, data processing, network control, and the like. Still further, exemplary embodiment(s) of the present disclosure could be used to detect or prevent security issues with a client-side scripting language, such as JavaScript, VBScript or the like.

While exemplary embodiment(s) of the present disclosure is described in association with an e-commerce collaborative transaction system, exemplary embodiment(s) of the present disclosure may contemplate any type of networks or transaction systems, including, for example, unsecure networks, public networks, wireless networks, closed networks, open networks, intranets, extranets, and/or the like.

Referencing the computer networked aspect of exemplary embodiment(s) of the present disclosure, each participant (customer/merchant) may be equipped with a computing system to facilitate online e-commerce transaction(s). The computing systems may be connected with each other via a data communication network. Participant computers and the e-commerce website system may be connected by a public network, which may be assumed to be insecure and open to eavesdroppers. In the illustrated implementation, the network is embodied as the Internet. In this context, the participant computers may or may not be connected to the Internet at all times. For instance, the participant computers may employ a modem or other connection interface to occasionally connect to the Internet, whereas the e-commerce website system might maintain a permanent connection to the Internet. It is noted that the network may be implemented as other types of networks, such as an interactive television (ITV) network. Specific information related to the protocols, standards, and application software utilized in connection with the Internet may not be discussed herein.

A first party to a transaction, first customer (buyer), may be any individual, business or other entity who desires to facilitate a transaction that permits the first customer to share the use and/or cost of purchasing a product/service on the e-commerce website. A second party to the transaction, second customer (buyer), may be any individual, business or other entity who desires to facilitate a transaction that permits the second customer to share the use and/or cost of purchasing the same product/service as the first customer. The term “customer”(s) may also be referred to herein as “consumer” (s), “purchaser” (s), “user” (s), “buyer”(s) or the like.

A third party to the transaction, merchant (seller), may be any individual, business or other entity who desires to facilitate a transaction that permits the first and second customers to share the use and/or cost of purchasing the merchant's item (product/service). For example, in one embodiment, a merchant may be an online bookstore such as AMAZON®.COM or may be an individual who desires to sell his/her item. The merchant may include retailers, wholesalers, distributors, dealers or other transaction-related companies, or any other type of product/service listing institutions, such as product/service sponsoring companies, or third party providers under contract with product/service providing institutions.

A fourth party to the transaction, a transaction host referred to herein as the e-commerce service provider, includes any provider of services that facilitates any type of transaction enabling at least two customers to find and locate a merchant product/service, which is available for use/sale, and thereafter share the use/cost of the product/service from the merchant. The e-commerce service provider establishes and maintains account and/or transaction information associated with the shared used/cost of the product/service. The e-commerce service provider may provide both the customers and the merchant with the ability to facilitate the collaborative transaction process of the exemplary embodiment(s) of the present disclosure. Unless otherwise specifically set forth herein, although referred to as “e-commerce service provider,” this term should be understood to mean any entity issuing an account to facilitate a collaborative online e-commerce website that enables a co-buy/co-share transaction, exchange or service over the Internet, and should not be limited to companies possessing or issuing any particular type of product/services.

Exemplary embodiment(s) of the present disclosure may include any convenient combination of hardware and software components configured to allow at least one customer to communicate with the merchant (and or another customer) via the e-commerce service provider's system or to communicate with the e-commerce website system. For example, the e-commerce website system might include a standard personal computer (PC) comprising a CPU, monitor, storage, keyboard, mouse, and communication hardware appropriate for the given data links (e.g., V.90 modem, network card, cable modem, etc.). The e-commerce website system also preferably includes application software configured to communicate over the data links, for example, a WWW browser such as NETSCAPE NAVIGATOR®, MICROSOFT INTERNET EXPLORER®, or any other present or future communication software which operates in accordance with the HTML or HTTP protocols. As will be appreciated, the e-commerce website system will typically include an operating system (e.g., WINDOWS® 95/98/2000, WINDOWS XP®, WINDOWS 7®, LINUX®, SOLARIS®, etc.) as well as various conventional support software and drivers typically associated with computers.

In a non-limiting exemplary embodiment, the e-commerce website system may be accessed via a personal data assistant (PDA) capable of communicating with the merchant via the data communication network. In a non-limiting exemplary embodiment, e-commerce website system may be a kiosk located, for example, at a mall, theme park, airport, or any other location from which a customer might wish to share use/costs of purchasing goods/services over the Internet. In a non-limiting exemplary embodiment, a retailer application programming interface (API) of the e-commerce website may be provided, wherein the API provides a particular set of rules and operations that the e-commerce website's software program(s), such as DOBA®, can follow to communicate with each other. The API may serve as an interface between such different software programs and facilitates their interaction to permit collaborative group buying to share the cost/use of the item offered for sale on the e-commerce website, for example. In such an example, the DOBA® server may not keep track of item inventory for each retailer but rather sources the product/service and reports the item's availability back to the customer(s).

A variety of conventional communications media and protocols may be used for the data communication links. Such data communication links might include, for example, a connection to an Internet Service Provider (ISP) over the local loop as is typically used in connection with standard modem communication, cable modem, DISH® networks, ISDN, Digital Subscriber Line (xDSL), or various wireless communication methods. The e-commerce website system might also reside within a local area network (LAN) which interfaces to the third-party payment system, such as PAYPAL®.COM, via a leased line (T1, DS3, etc.). Such communication methods are well known in the art, and are covered in a variety of standard texts.

As the exemplary embodiment(s) of the present disclosure may be best deployed in the context of a large customer-base, the e-commerce website system preferably is in communication with the Internet. As used herein, the term Internet refers to the global, packet-switched network utilizing the TCP/IP suite of protocols. Nevertheless, the exemplary embodiment(s) of the present disclosure may be implemented in other network contexts, including any future alternatives to the Internet, as well as other suitable internetworks based on other open or proprietary protocols.

The e-commerce website system may include any combination of hardware, software, and networking components configured to transmit, receive and process transaction-related data to and from the customer(s) and merchants and transmit, receive and process transaction-related data to and from the payment service provider(s). In addition, the e-commerce website system provides a suitable website or other Internet-based graphical user interface which is accessible by customers and the merchant. The term website as it is used herein is not meant to limit the type of documents and applications that might be used to interact with a customer(s) and/or merchant. For example, a typical website might include, in addition to standard HTML documents, various forms, JAVA® applets, Javascript, active server pages (AS), common gateway interface scripts (CGI), extensible markup language (XML), dynamic HTML, cascading style sheets (CSS), helper applications, plug-ins and the like.

The customer(s) account authorization portion of the e-commerce website system preferably includes any combination of hardware and software components configured to transmit, receive and process collaborative transaction-related data to and from the customer(s) and merchant, and a database. The database may be a relational database comprising various records for managing and translating a variety of information, such as customer(s) and/or merchant account numbers, transaction data, conditions/rules, etc. In an exemplary embodiment, database may have a plurality of records. Each record may be associated with a customer and/or merchant account number, which is stored in a field of the record. In addition to a field for storing a customer(s) and/or merchant account number, each record may include a field for storing a monetary value associated with the customer(s) and/or merchant account number. The record may also contain a field for indicating rules or conditions for use of the e-commerce website account number.

Because the system of the exemplary embodiment(s) of the present disclosure is directed to permitting customer(s)/merchant collaborative transactions over the Internet, in one embodiment of exemplary embodiment of the present disclosure, the records of the database that are associated the customer(s) and/or merchant account numbers may store identifying information of the purchasers or users of the customer and/or merchant account numbers. As used herein, “identifying information” of the customer/merchant may include name, address, social security number, credit card or debit card numbers or any other information that can be used to obtain the identity of a customer and/or merchant.

In a non-limiting exemplary embodiment, the records of the database that are associated with customer(s) and/or merchant account numbers may store identifying information of owners of the customer and/or merchant account numbers but the third party payment provider system may be configured to not provide such identifying information to persons, entities or systems that are not associated with or affiliated with payment service provider. For example, while the records that are associated with customer(s) and/or merchant account numbers that store the names and/or addresses of owners of the customer(s) and/or merchant account numbers, the payment provider system may not distribute such information to customer(s) and/or merchants or other third-party entities such as banks, credit bureaus or the like for obvious privacy concerns.

The system(s) of the exemplary embodiment(s) of the present disclosure may include a web (host) server or other computer system(s) managed by the e-commerce service provider including a processor for processing digital data, a memory coupled to said processor for storing digital data, a user interface coupled to the processor for inputting digital data, an application program stored in said memory and accessible by said processor for directing processing of digital data by said processor, a display coupled to the processor and memory for displaying information derived from digital data processed by said processor, a plurality of additional servers (such as Mysql server, search server), a database (having tables), at least one API, a shipping gateway and a payment gateway, for example. Such components may include customer(s) data, merchant data, item data, shipping data and/or like data that could be used in association with the exemplary embodiment(s) of the present disclosure. The database may be any type of database, such as relational, hierarchical, object-oriented, and/or the like. The database may be organized in any suitable manner, including as data tables or lookup tables.

Association of certain data may be accomplished through conventional data association technique known and practiced in the art. For example, the association may be accomplished either manually or automatically. An association step may be accomplished by a database merge function, for example, using a “key field” in each of the customer and merchant data tables. A “key field” may partition the database according to the high-level class of objects defined by the key field. For example, a certain class may be designated as a key field in both the first data table and the second data table, and the two data tables may then be merged on the basis of the class data in the key field. In this exemplary embodiment, the data corresponding to the key field in each of the merged data tables is preferably the same. However, data tables having similar, though not identical, data in the key fields may also be merged by using other conventional searching protocols, for example.

### Non-Limiting Exemplary Hardware Architecture

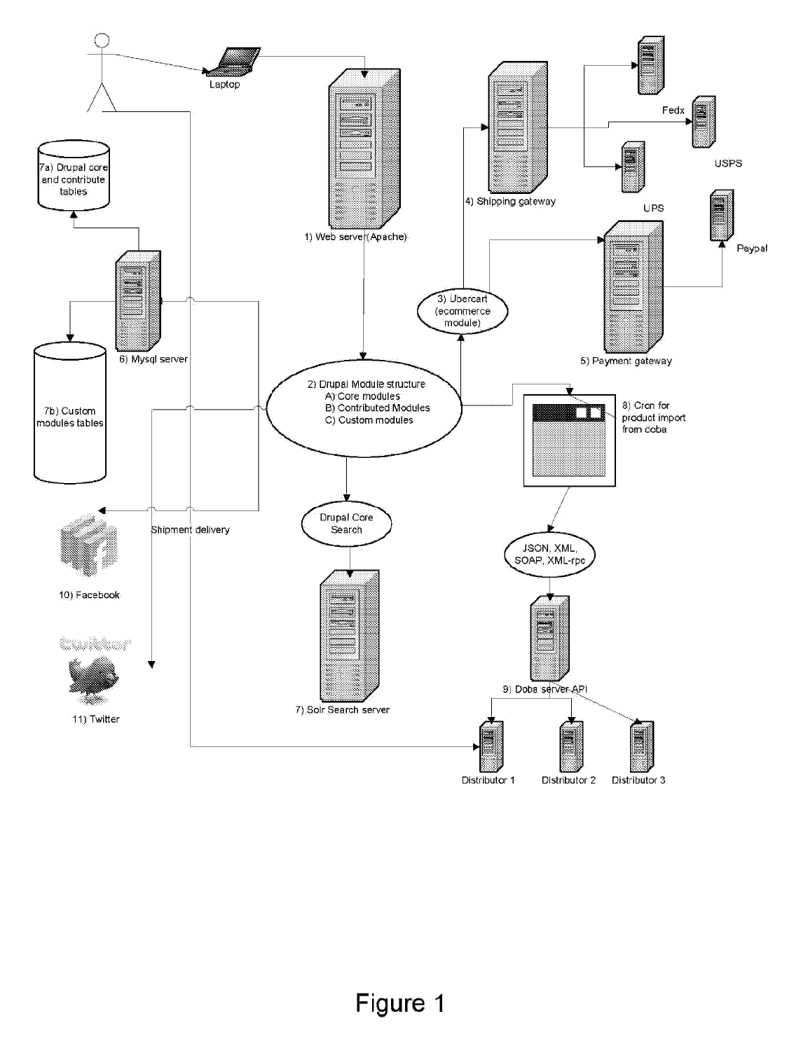

As perhaps best shown ion FIG. 1, web (host) server may be an APACHE® web server. Such a web server can refer to either the hardware (the computer) or the software (the computer application) that delivers content to be accessed through the Internet. APACHE® supports a variety of features, many implemented as compiled modules which extend the core functionality of the present disclosure. These can range from server-side programming language support to authentication schemes. Some common language interfaces support Perl, Python, Tcl, and PHP.

In a non-limiting exemplary embodiment(s), PHP may be used as server side scripting language to carry out selected functions applicable to the collaborative buy/use e-commerce processes. Exemplary authentication modules may include mod_access, mod_auth, mod_digest, and mod_auth_digest, the successor to mod_digest. A sample of other features may include SSL and TLS support (mod_ssl), a proxy module (mod_proxy), a URL rewriter (also known as a rewrite engine, implemented under mod_rewrite), custom log files (mod_log_config), and filtering support (mod_include and mod_ext_filter).

In a non-limiting exemplary embodiment(s), compression methods on APACHE® may be used, which include the external extension module, mod_gzip, implemented to help with reduction of the size (weight) of web pages served over HTTP. A ModSecurity module may also be implemented as an intrusion detection and prevention engine for the web applications of the present disclosure. APACHE® logs can be analyzed through a web browser using free scripts such as AWStats/W3Perl or Visitors.

In a non-limiting exemplary embodiment(s), the web (host) server may be installed with DRUPAL®, which is a content management system (CMS) and content management framework (CMF) written in PHP and distributed under the GNU General Public License. DRUPAL® CORE includes optional modules which can be enabled by the administrator to extend the functionality of the e-commerce website. For example, DRUPAL® CORE distribution provides a number of features, including: access statistics and logging; advanced search; blogs, books, comments, forums, and polls; caching and feature throttling for improved performance; descriptive URLs; multi-level menu system; multi-site support; multi-user content creation and editing; openID support; RSS feed and feed aggregator; security and new release update notification; user profiles; various access control restrictions (user roles, IP addresses, email); and workflow tools (triggers and actions) that may be implemented to carry out the collaborative buy/use functions of exemplary embodiment(s) of the present disclosure.

Additional modules that may be implemented by the present disclosure may include a user module that provides user management such as: add, edit and delete user functions and adding different user roles and permissions. A system module may be employed to provide administration of different pluggable modules and themes. A node module may be implemented to add content in the system, which will be visible and maintained in a backend of the system. For example, products/services displayed for shared use/purchase may be identified by a node. A filter input module may provide input validation of the content inserted in the e-commerce website. This helps in restricting a user to add buggy content which can alter with the system. A watchdog module may be included to enable log events in the database that are happening in the system like a site log. A menu module may be employed to allow administrators to customize the site navigation menu. A path module may be employed to allow users to rename URLs. A taxonomy module may be employed to enable the categorization of content. A block module may be employed to provide the block management that will be shown on the frontend and backend of the e-commerce website for adding and editing dynamic and static blocks of content on different region of system

A non-limiting exemplary embodiment(s) of the present disclosure may further include contributed modules, which are contributed in the DRUPAL® community and provides additional functionality by offering image galleries, custom content types and content listings, WYS|WYG editors, private messaging, and third-party integration tools, for example.

Exemplary contributor modules that may be implemented may include: a content construction kit (CCK) that adds custom fields to the nodes using a web browser; a search module enabling a user to perform sophisticated searches. For example, a search engine may be built that returns results based on relevancy of the search term as well as other defined factors. An APACHE® SOLR search integration module may be employed to integrate DRUPAL® with the APACHE® SOLR search platform. The SOLR search platform may be used as a replacement for core content search and boasts both extra features and better performance. Among the extra features is the ability to have faceted search on facets ranging from content author to taxonomy to arbitrary CCK fields. An APACHE® SOLR UBERCART® integration may add the sku (model), sell price, and list price to a SOLR index and thereby enables model, list price, sell price, weight, height, length, width facet blocks. The price blocks can be divided in divisions. For example, from 0 to 20 lbs. and from 20 to 40 lbs. Such divisions are configurable per block.

A non-limiting exemplary embodiment(s) of the present disclosure may further include a TWITTER® module that provides API integration with the TWITTER® micro-blogging service and API-compatible alternatives such as Identi.ca. Such a module allows users to associate one or more TWITTER® accounts with their DRUPAL® user account, have their tweets displayed in a sidebar block or on their user profile, and post to their own TWITTER® account or a site-wide TWITTER® account whenever they create new content on the e-commerce website. The e-commerce website may display a TWITTER® icon that creates a TWITTER® button on the product page of a FACEBOOK® button module.

A non-limiting exemplary embodiment(s) of the present disclosure may further include, the FACEBOOK® connect module may enable a user to login into site using their FACEBOOK® username and password and providing functionality to invite FACEBOOK® friends.

A non-limiting exemplary embodiment(s) of the present disclosure may further include a user point module that adds user points upon successfully registered on the e-commerce website. A node invite module may be employed to create networks of customers and/or merchants and thereby encourage growth of customer groups having similar interests; i.e. gamers, mothers, surfers, etc. Such a node invite module may provide an invite-a-friend feature thereby allowing customer(s)/merchant(s) of the e-commerce website to send and track invitations to join the e-commerce website network. A user relationship admins module may be employed to create relationship types (friend, coworker, etc) for the customer(s) on the e-commerce website. Relationship types can be setup to be one-way or mutual. If a relationship type is one-way (customer) only the requester is shown as being related to the requestee. Relationship types can also be set as needing or not needing approval from the requestor and/or requestee, respectively.

The admins module may also provide each customer with the option to auto approve relationships on a per-relationship type basis. Such a module may be used to create friends in the e-commerce website network. A rules modules may be employed to allow site administrators to define conditionally executed actions based on occurring events (known as reactive or CEA rules). Such a rules module may be used for sending notifications as well as posting activity in FACEBOOK® status messages, for example.

A non-limiting exemplary embodiment(s) of the present disclosure may further include a secure pages module that ensures a user is running on a secure page when he/she creates and/or edits content, views user details, and/or administers the site. Furthermore, a secure pages hijack prevention module may be employed, which may be add-on to the secure pages module, for preventing hijacked sessions from accessing SSL pages, yet still allow users to stay logged in when browsing non-SSL pages. The user login form is also secured, both on the user page and the login block.

A non-limiting exemplary embodiment(s) of the present disclosure may further include DRUPAL® core cache module that enables the database cache in DRUPAL® for anonymous users. An auth cache module may also be employed for creating user cache associated with logged in users (customers and merchants). A change password module may be employed to enable the user to change his/her password. A saved search module may be employed to enable a user to save his/her search and later view the saved searches.

A non-limiting exemplary embodiment(s) of the present disclosure may further include a privatemsg module that allows users to send private messages to each other on the e-commerce website. Such private messages encourage collaboration between the users to purchase/sell items for community oriented sites, such as forums and social networking sites. Many additional features may be made available as separate modules. A persistent login module may be employed to provide a “Remember Me” option (or the like) in the user login form. A fivestar voting module may be employed to add a voting widget to items (products/services) and thereby enables users to rate products/services base on their experience. A lightbox module may be employed to provide popup blocks for login and signup. A quicktabs module may be employed to provide javascript tabs in the front-end of the e-commerce website similar to a homepage and product pages of the e-commerce website. A wishlist module may be employed to permit users to add an item to a wishlist.

A non-limiting exemplary embodiment(s) of the present disclosure may further include additional custom modules. For example, a custom slider module may be employed to add slider on the home page and on the catalog page of the website. The custom TWITTER® module may provide a user invite block for TWITTER® users registered on the e-commerce website. Unregistered TWITTER® users may also be invited onto the e-commerce website with such a module. A custom user registration module may be employed for changing an appearance of forms provided on the e-commerce website. For example, such a module may change default registration forms provided by DRUPAL®.

A DOBA® order module may be employed to integrate the DOBA® services in DRUPAL®. The DOBA® module may be used to provide an administration section wherein an administrator can update DOBA® API details. As an example, SOAP XMI services may be used to interact with the DOBA® module for importing items onto the e-commerce website and/or ordering items during checkout.

A non-limiting exemplary embodiment(s) of the present disclosure may further include additional custom modules. For example, an email notification module may be implemented and sent to a user when his/her book keeping time ends. User feedback notifications may be performed by this module as well.

### Non-Limiting Exemplary Friend Sheet Module

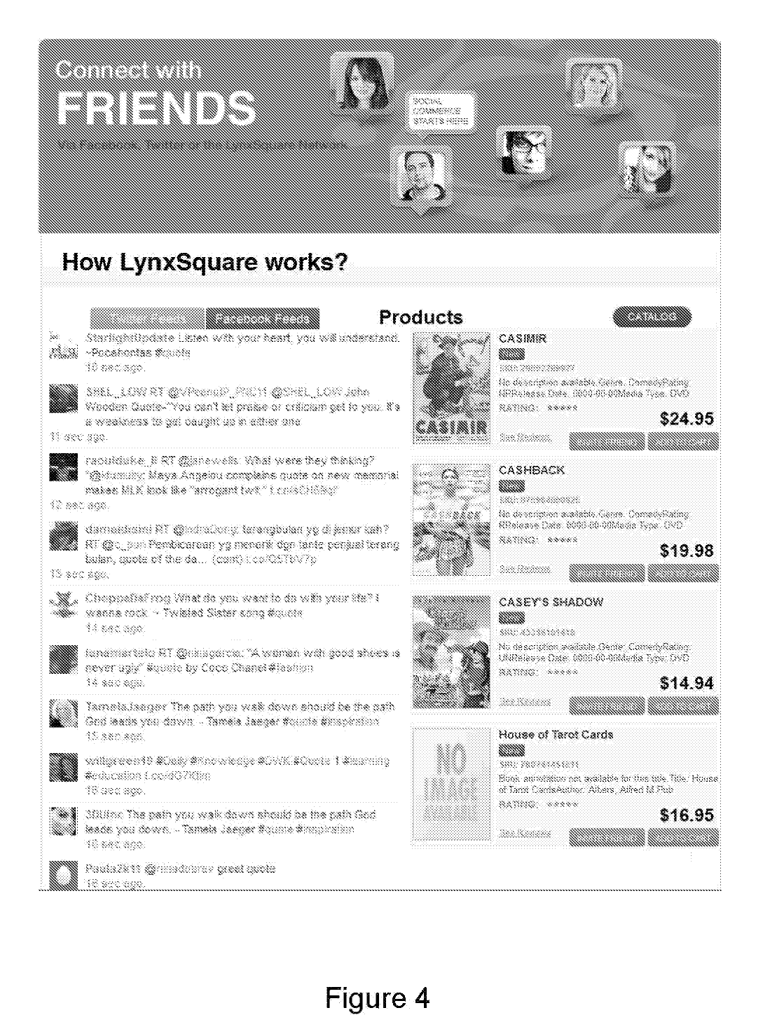

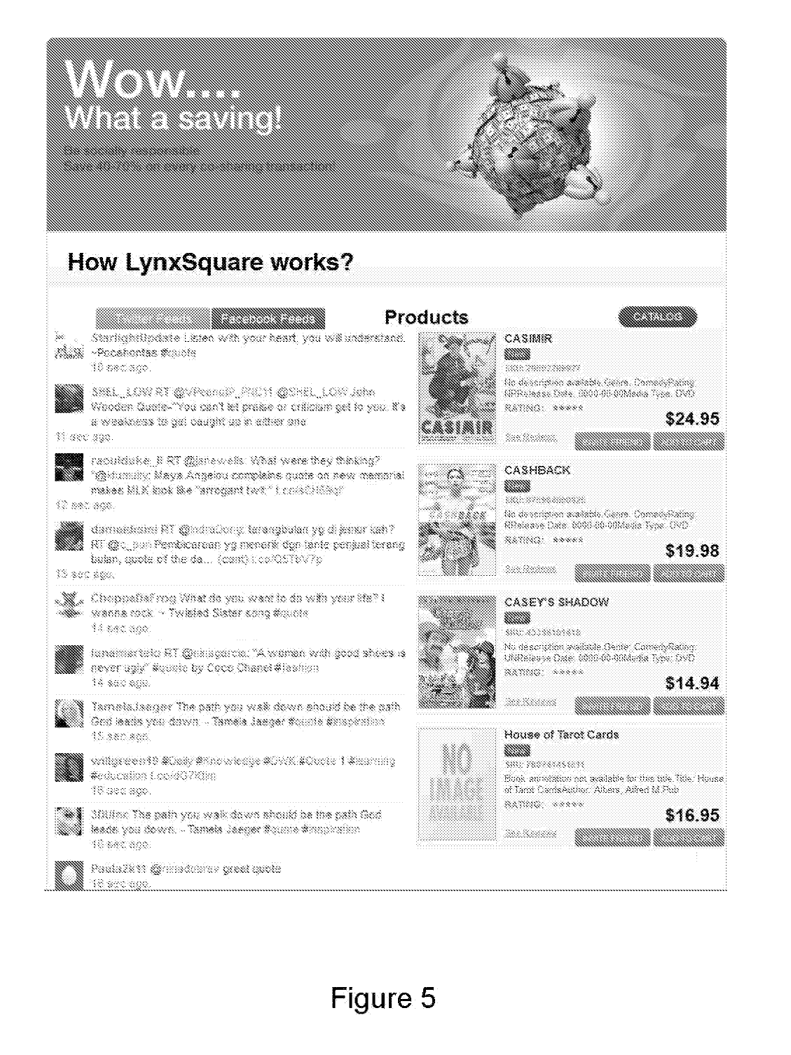

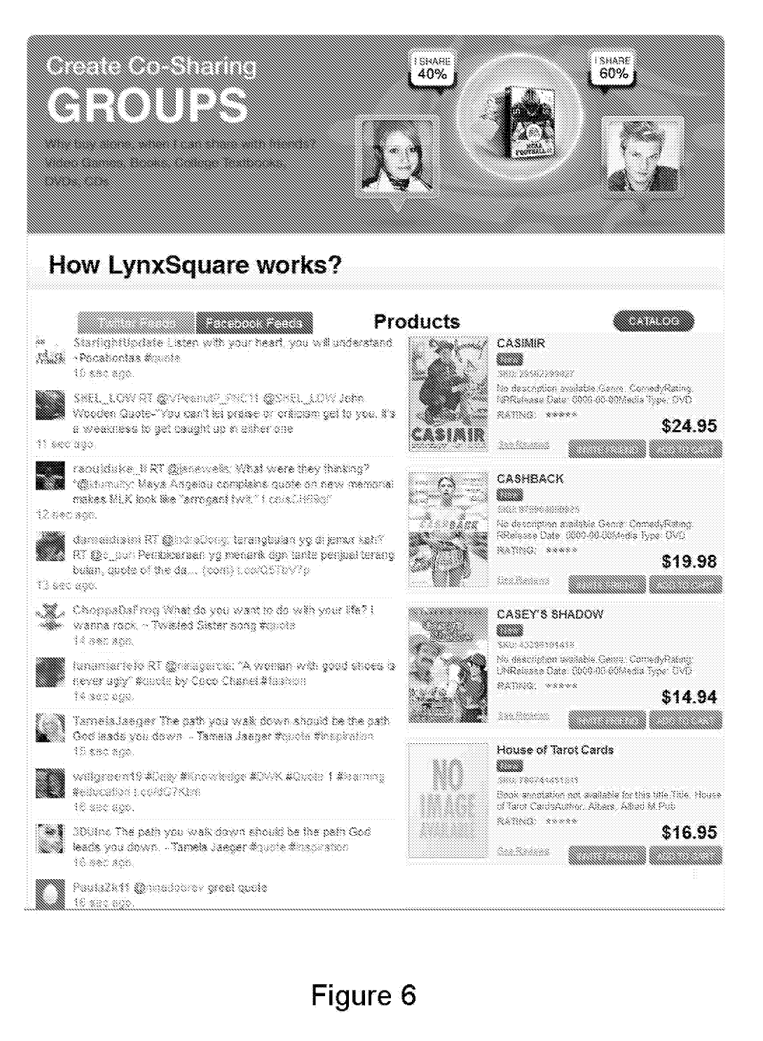

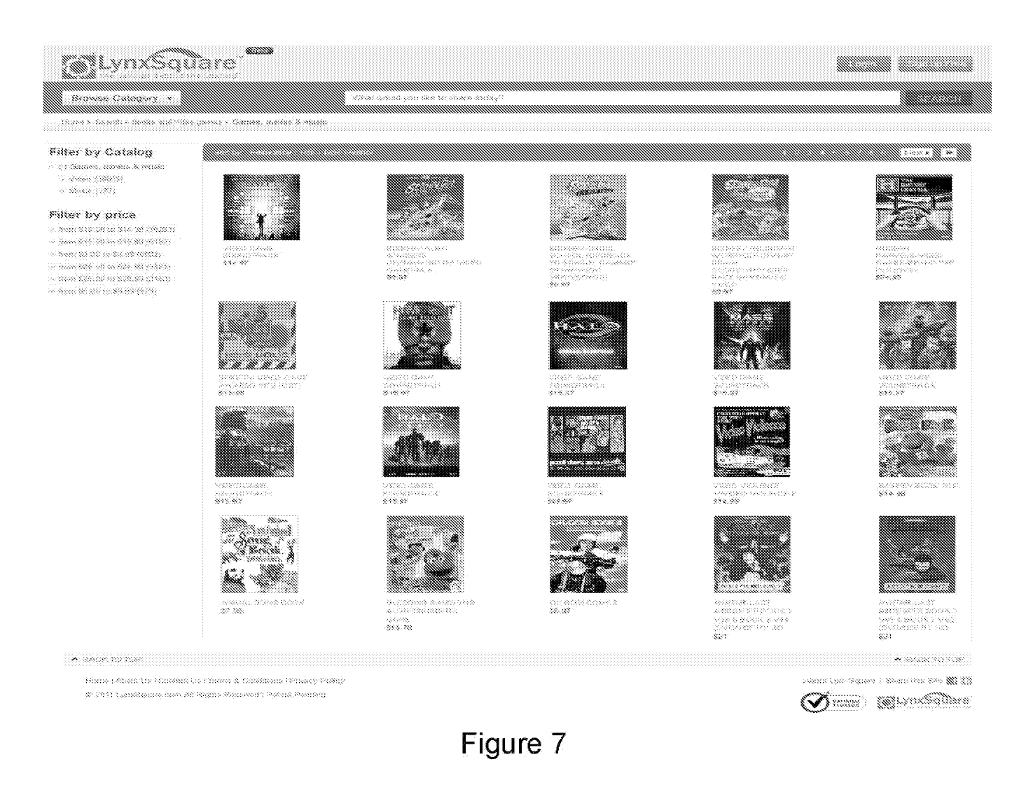

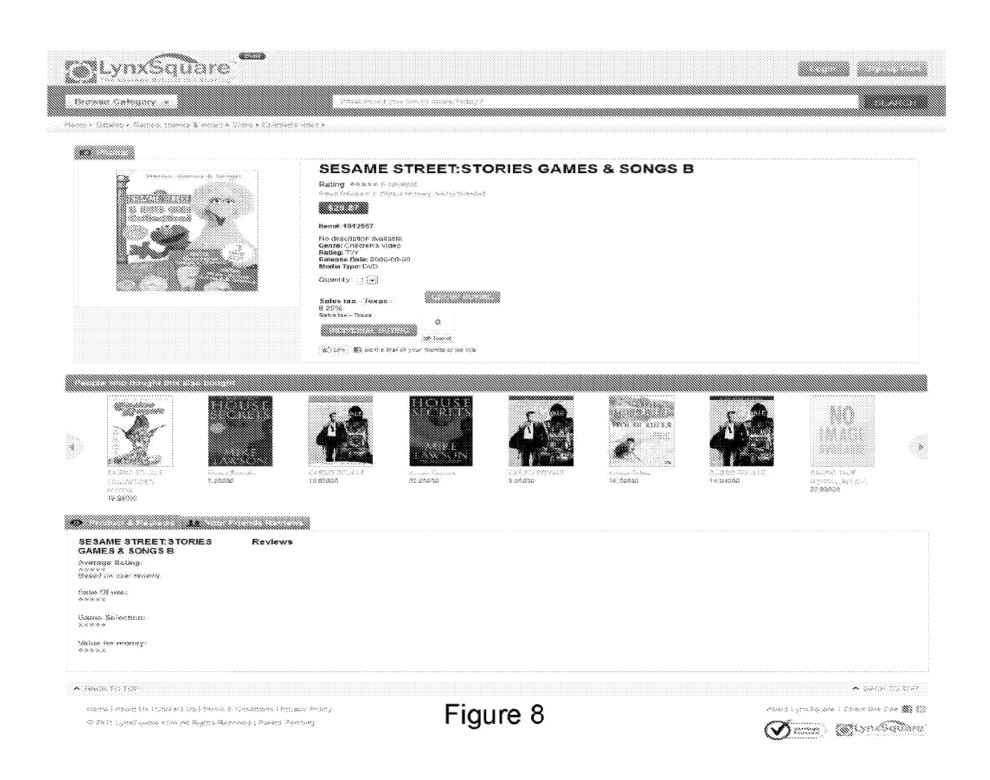

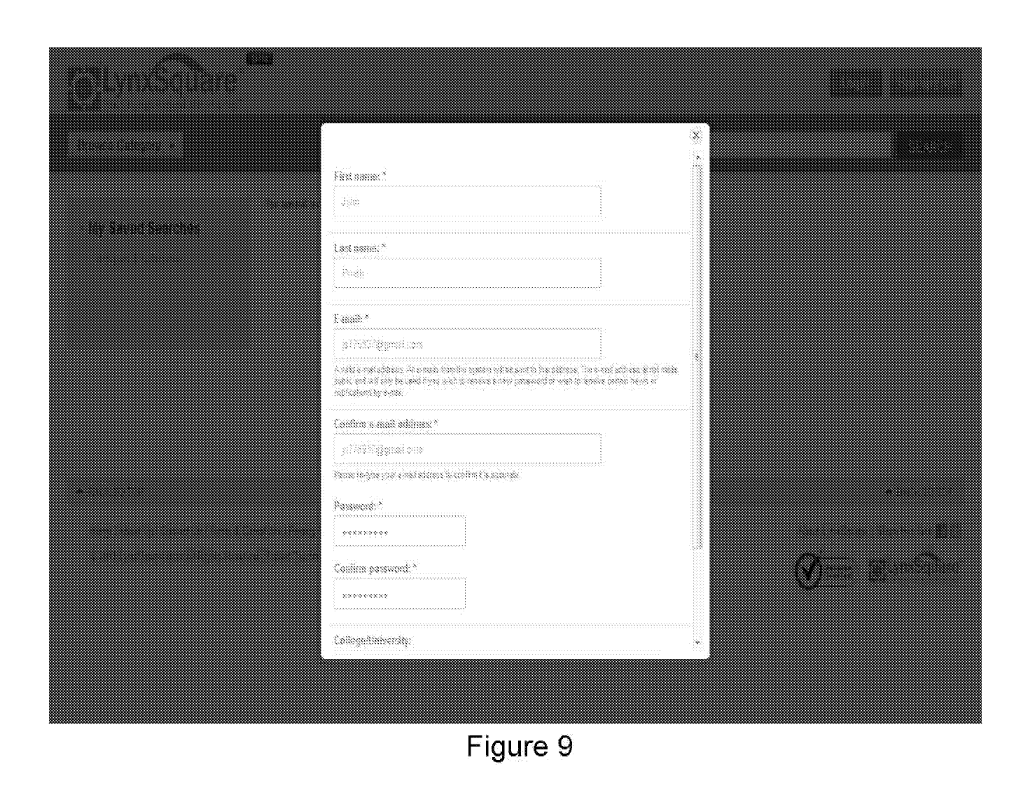

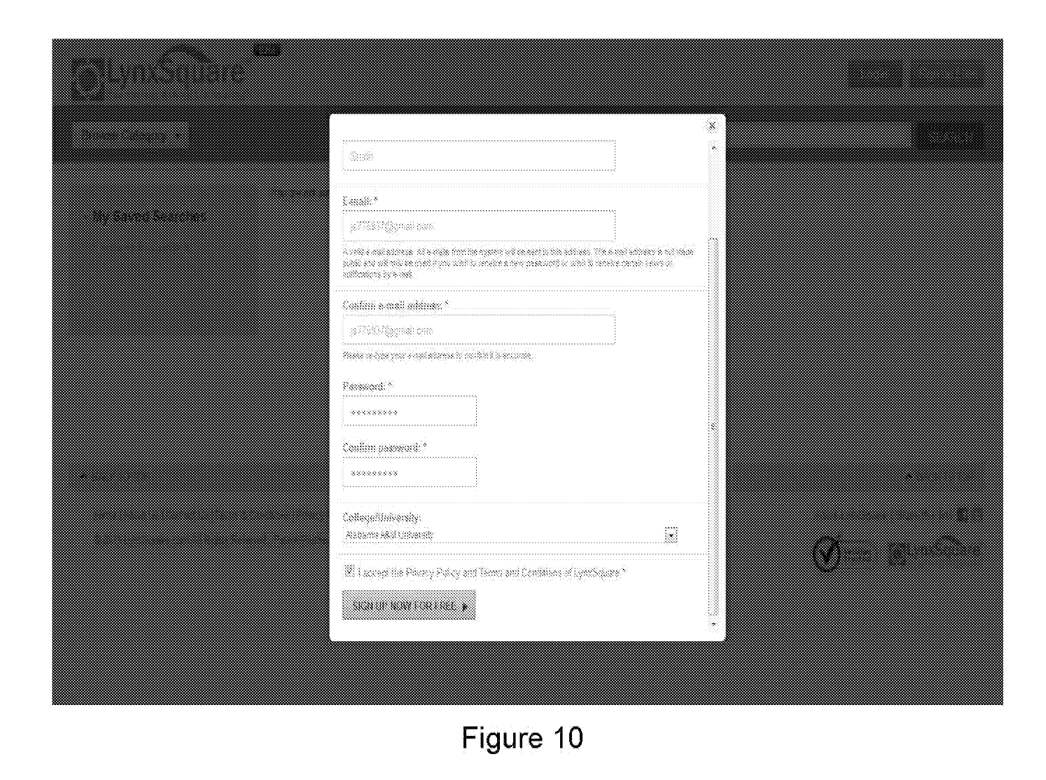

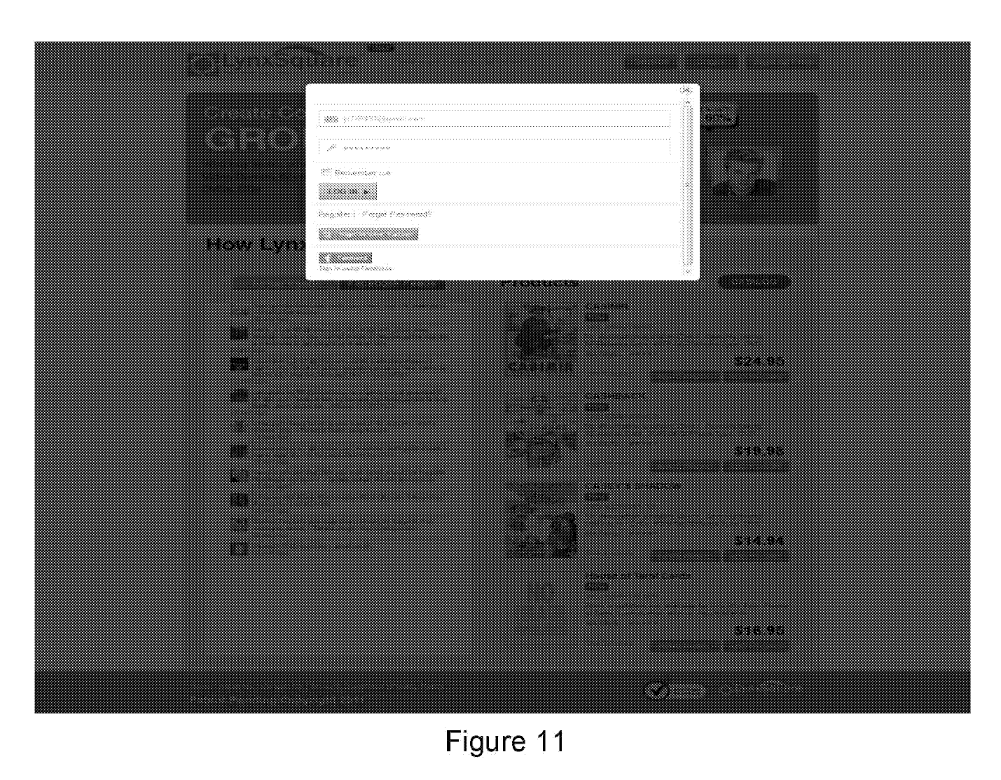

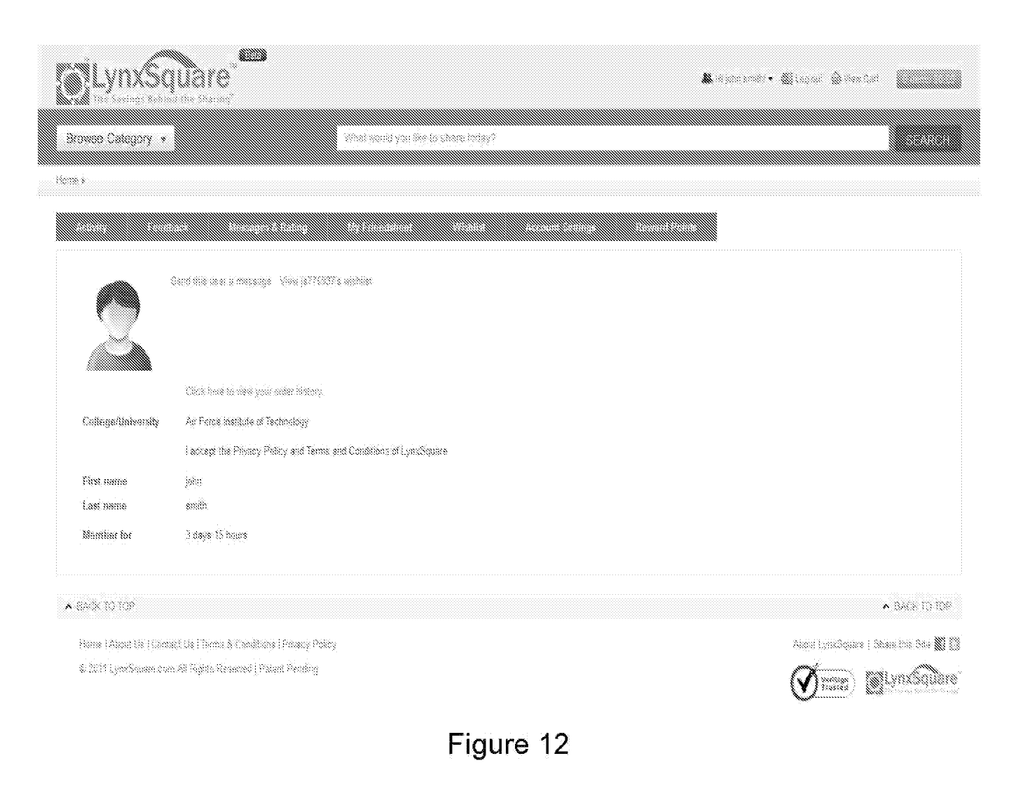

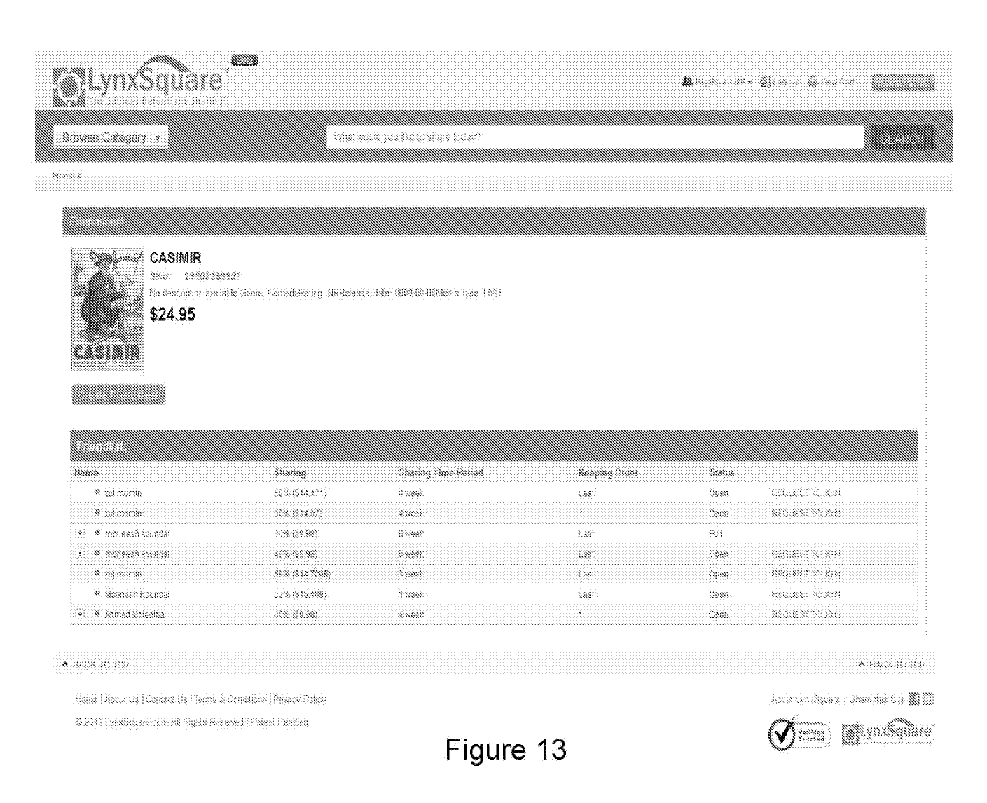

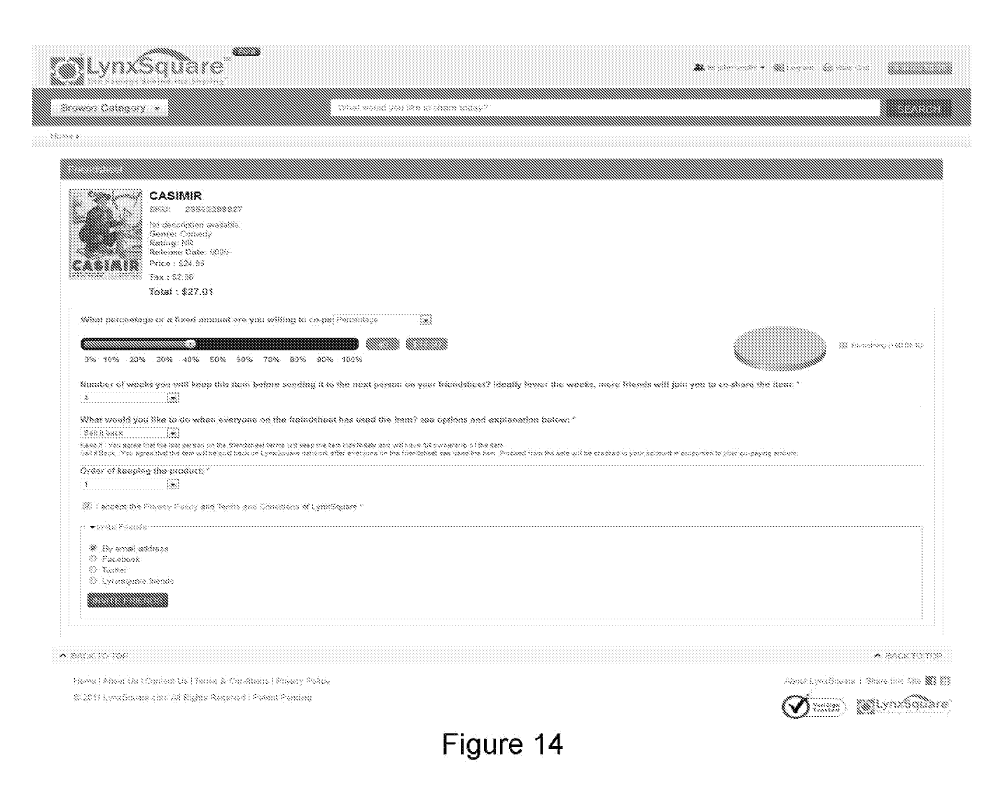

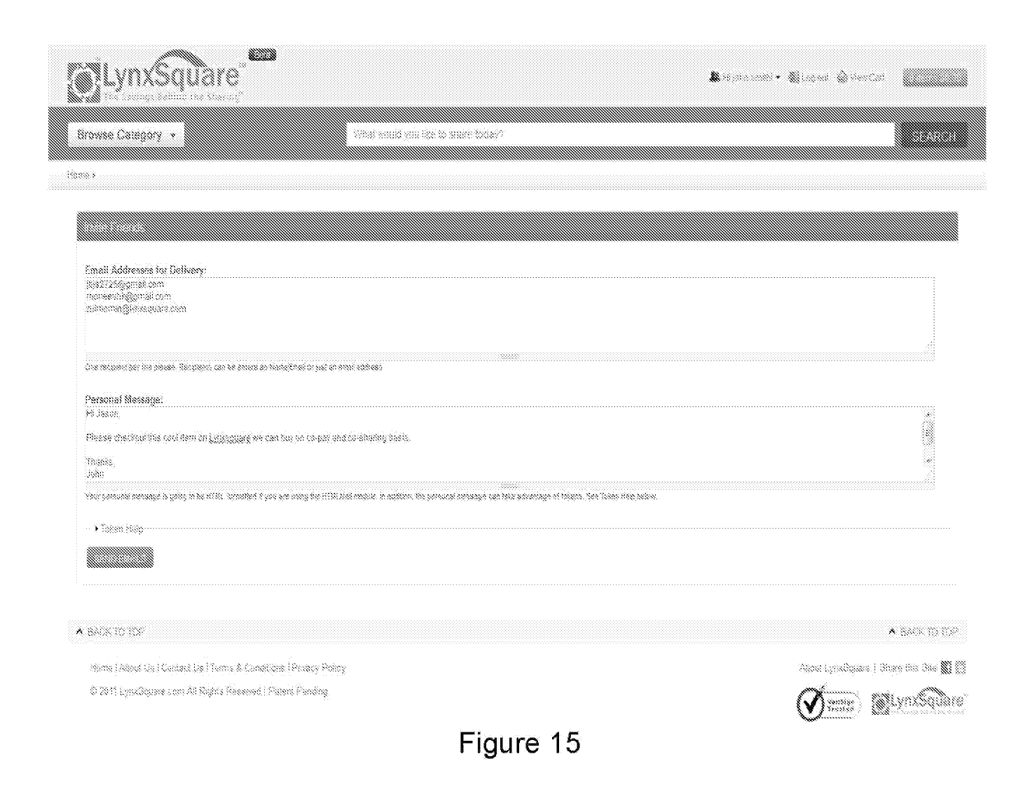

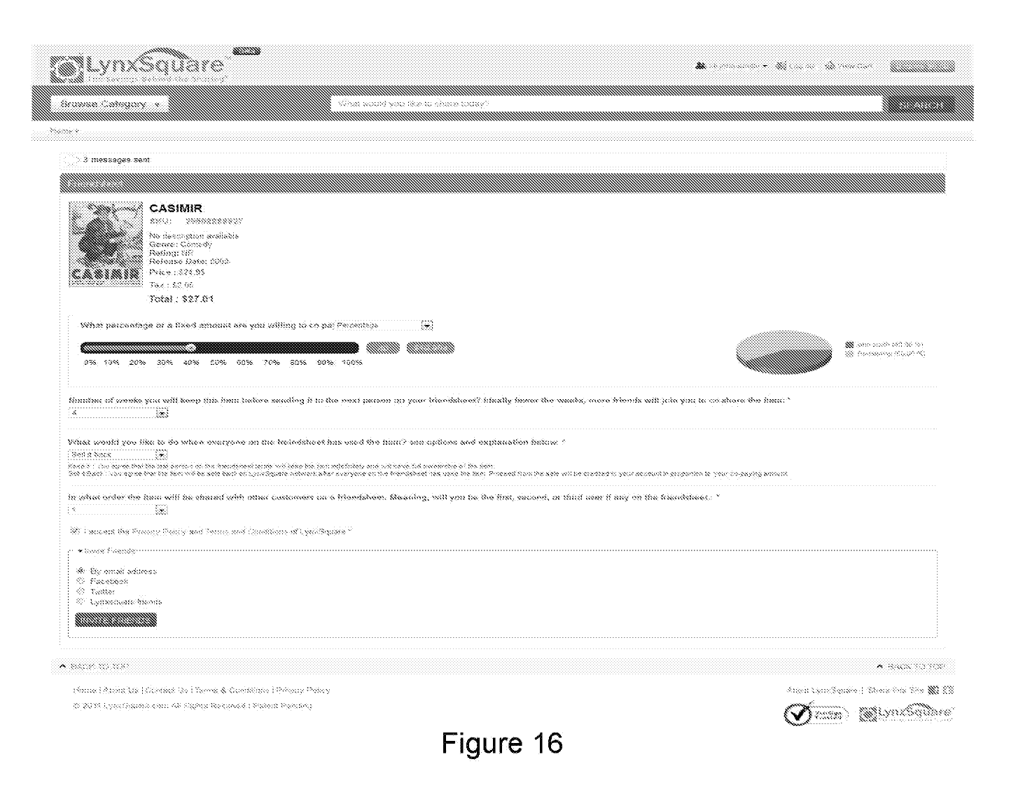

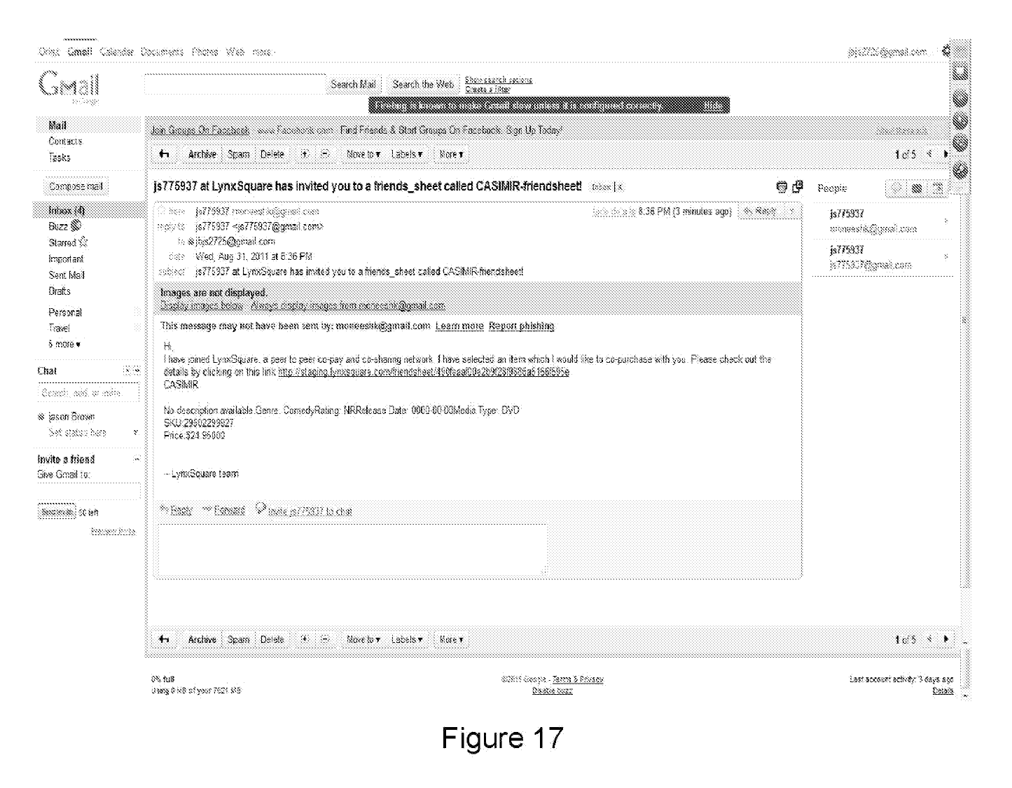

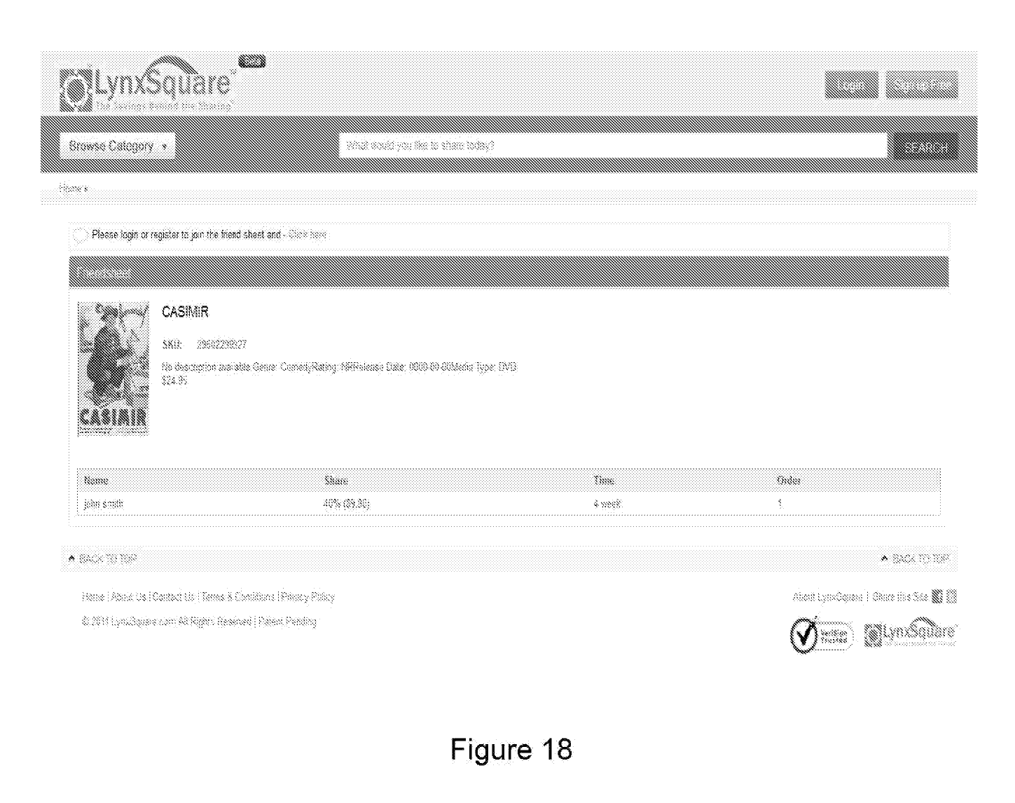

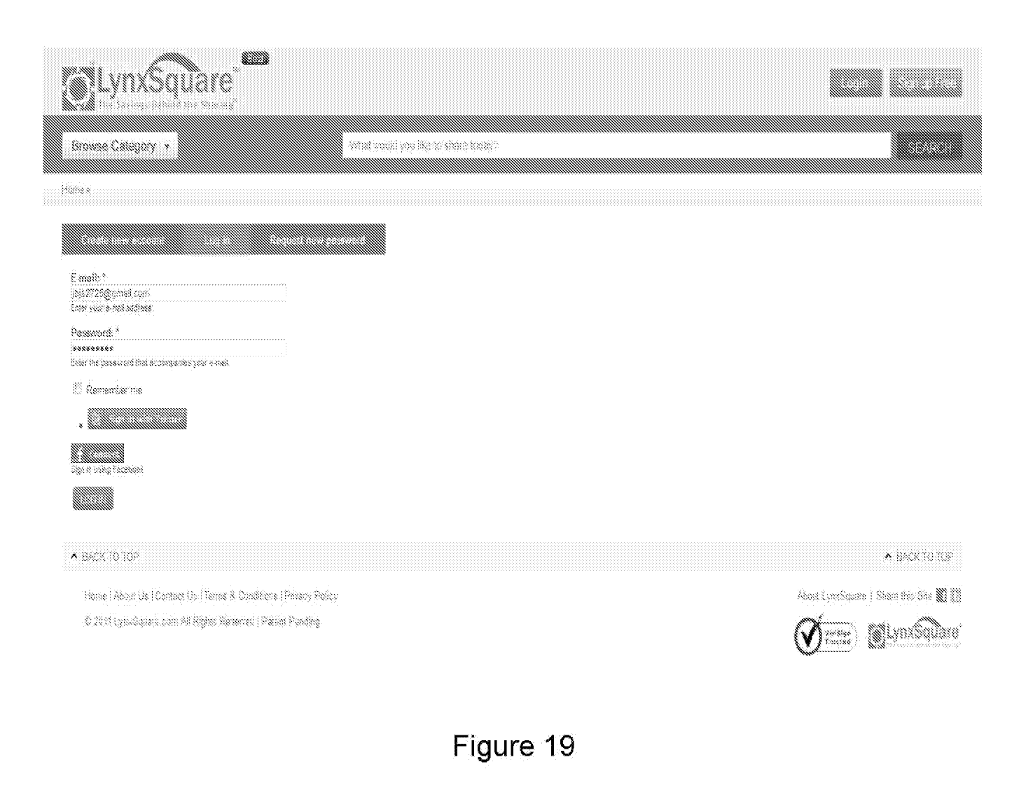

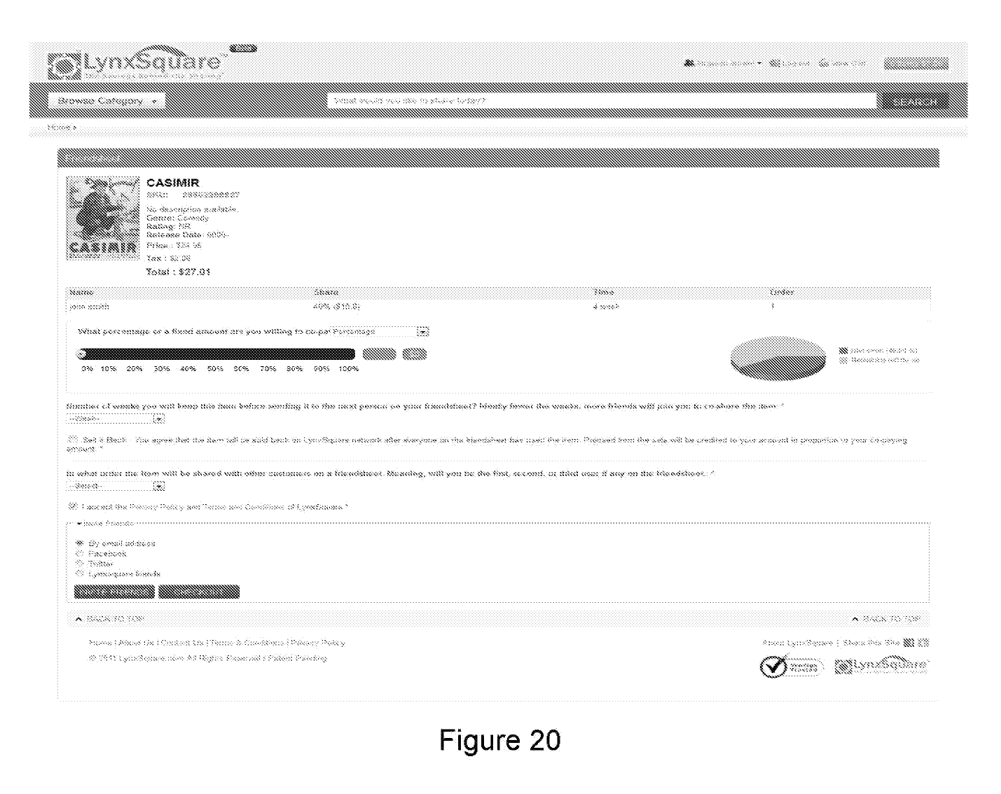

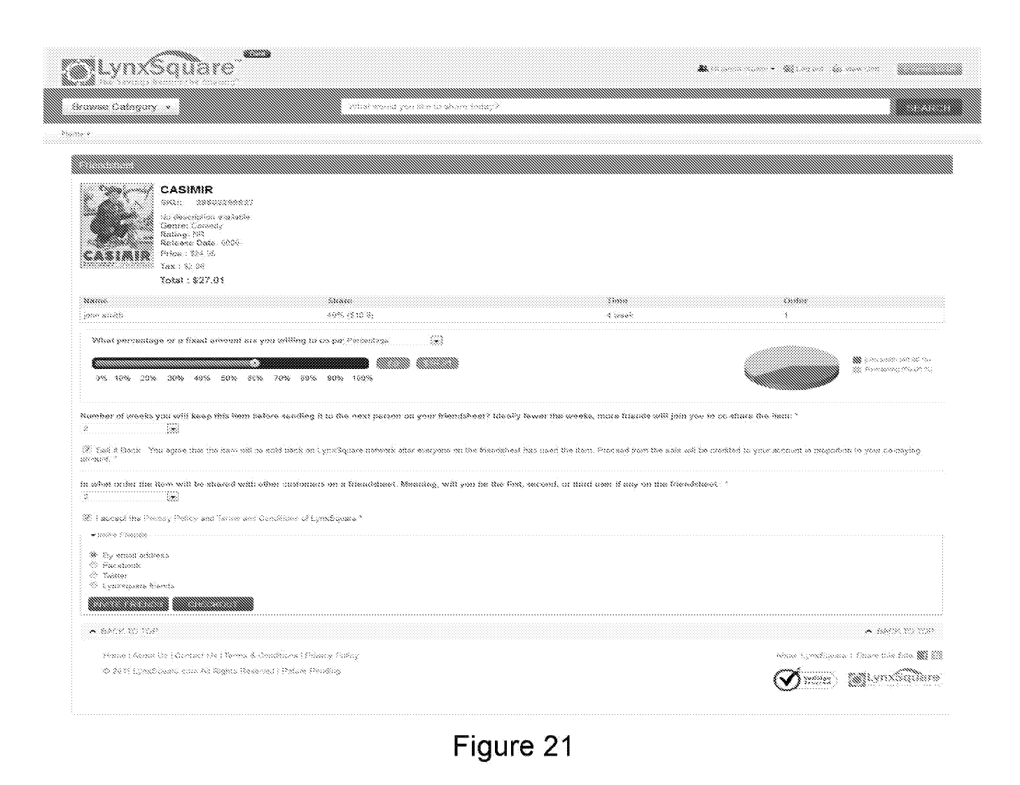

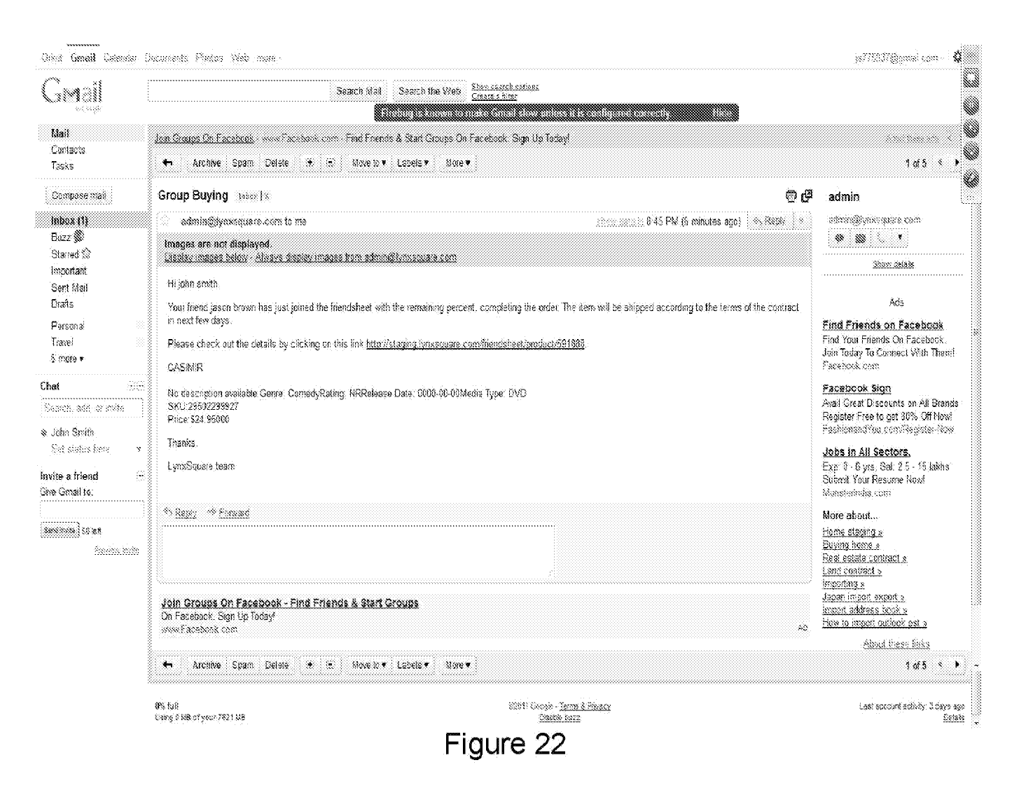

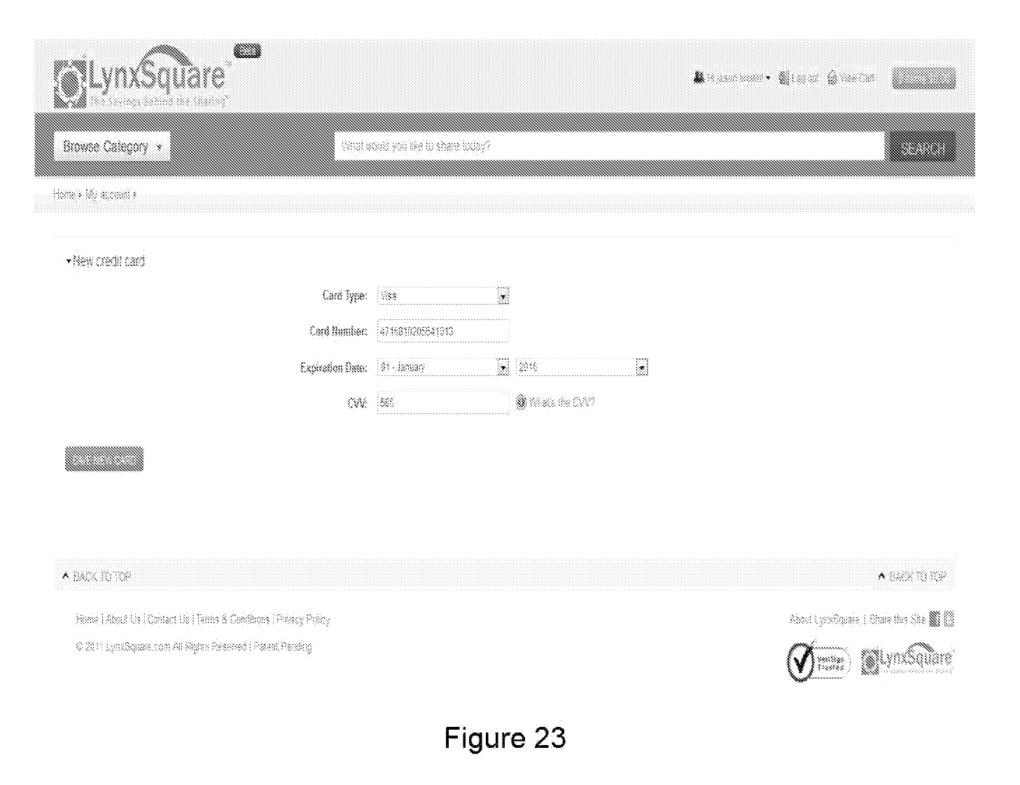

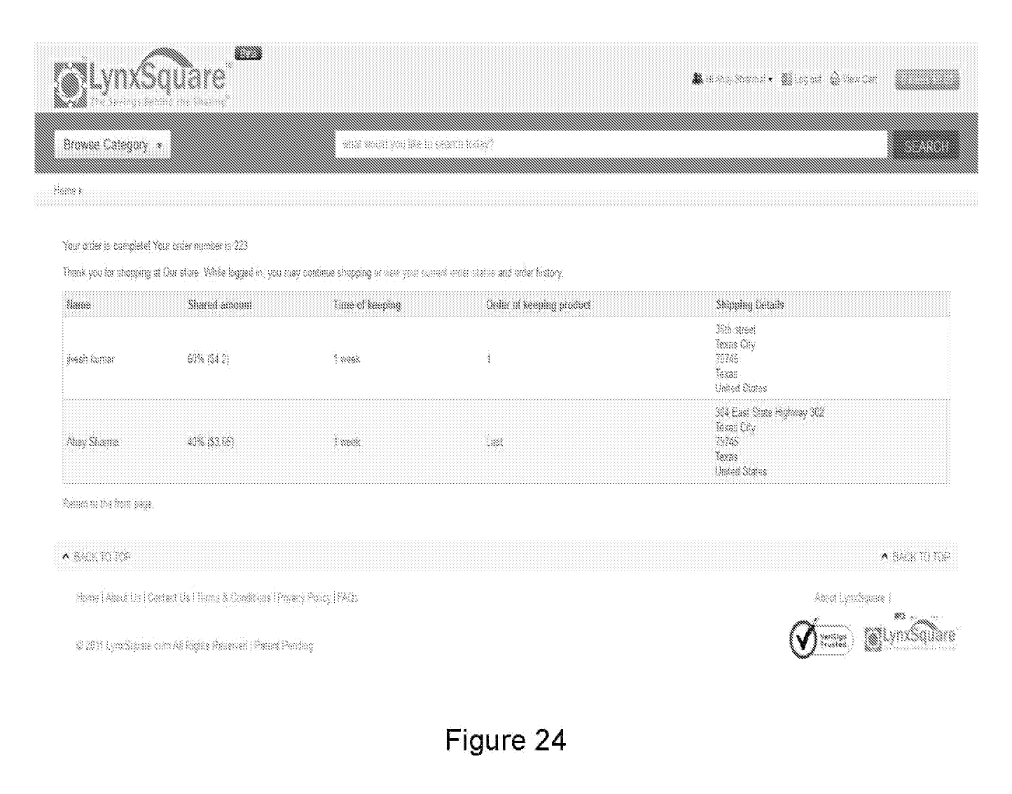

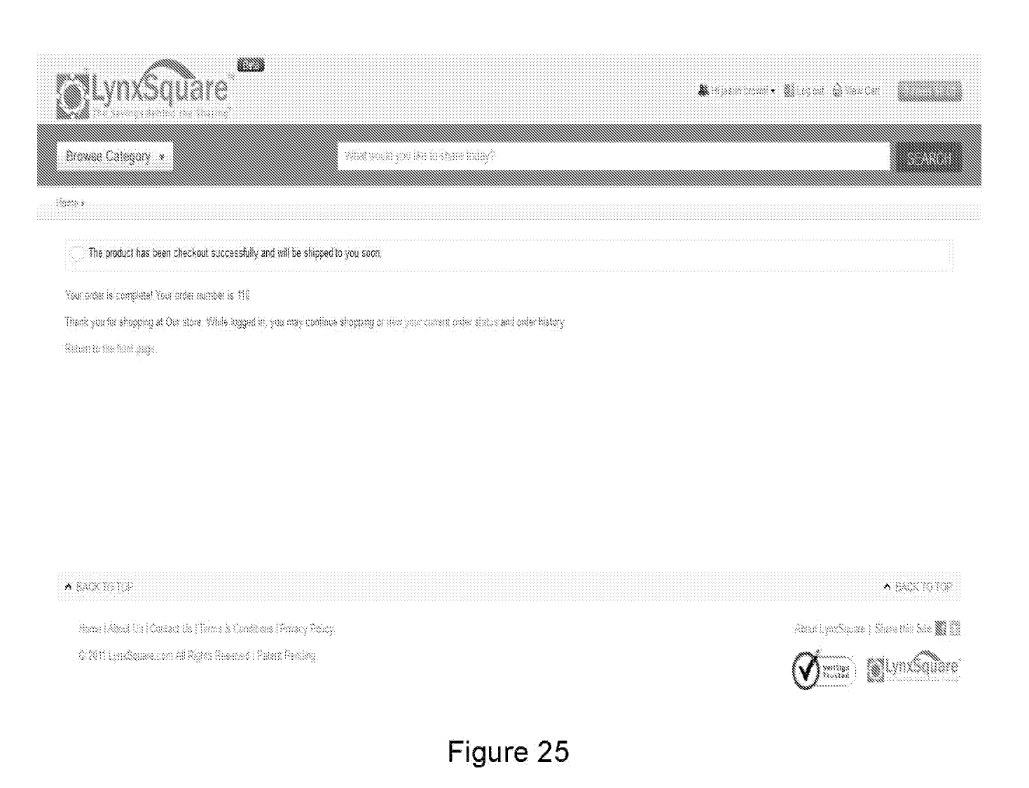

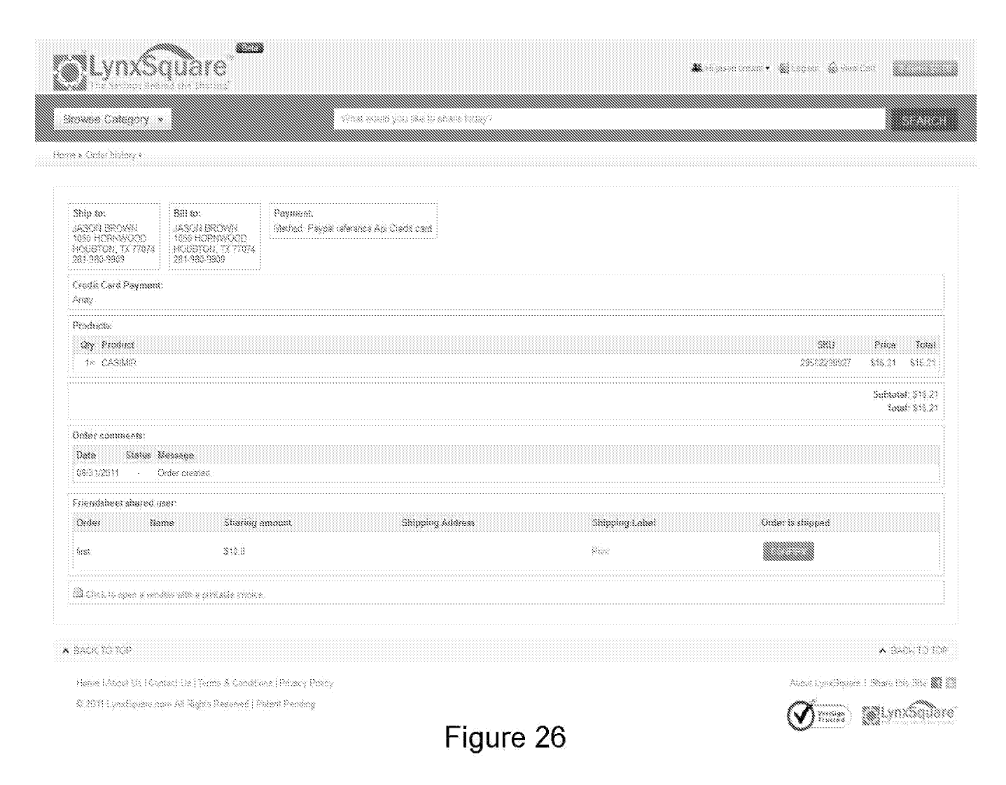

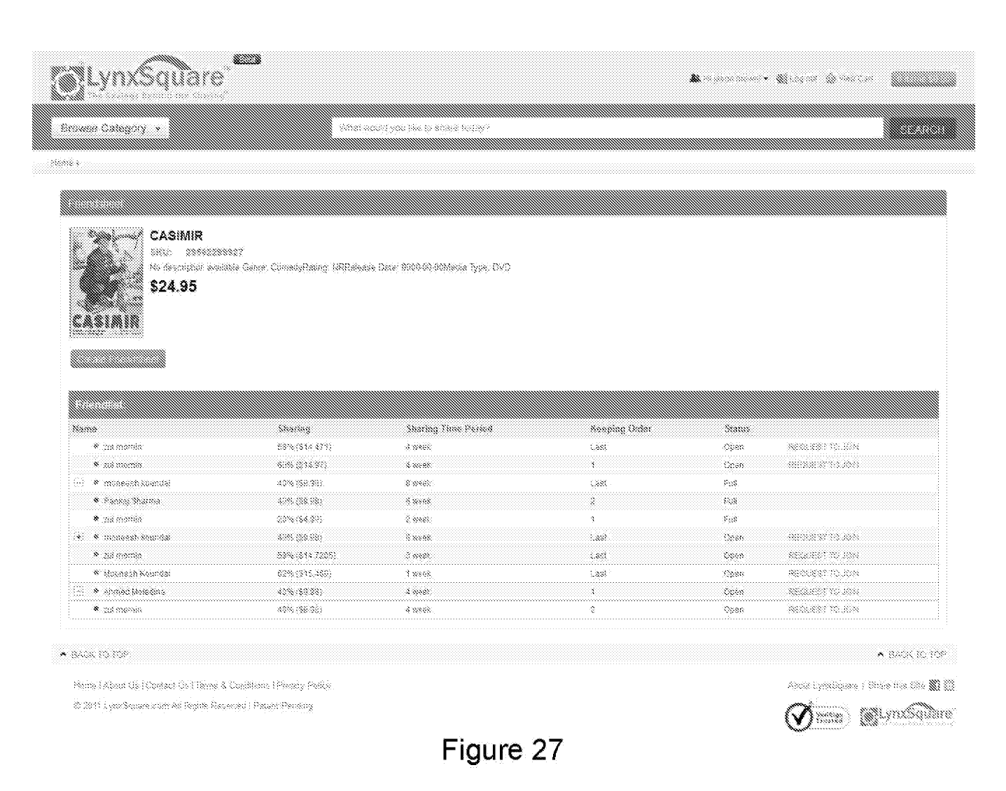

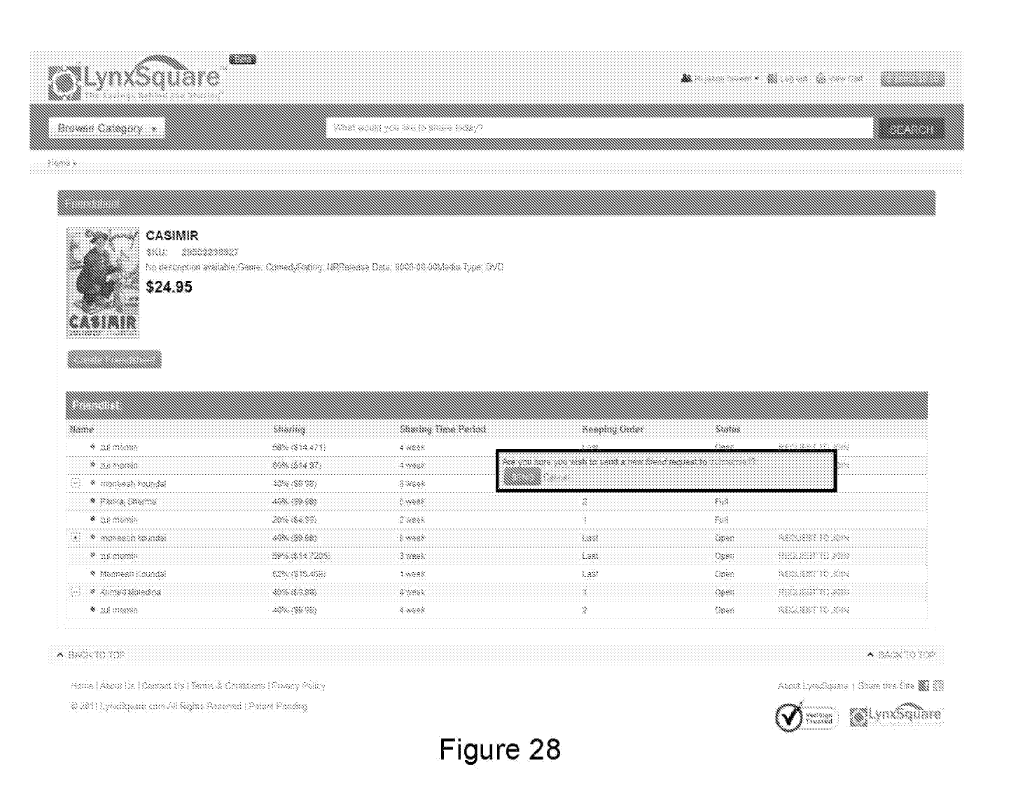

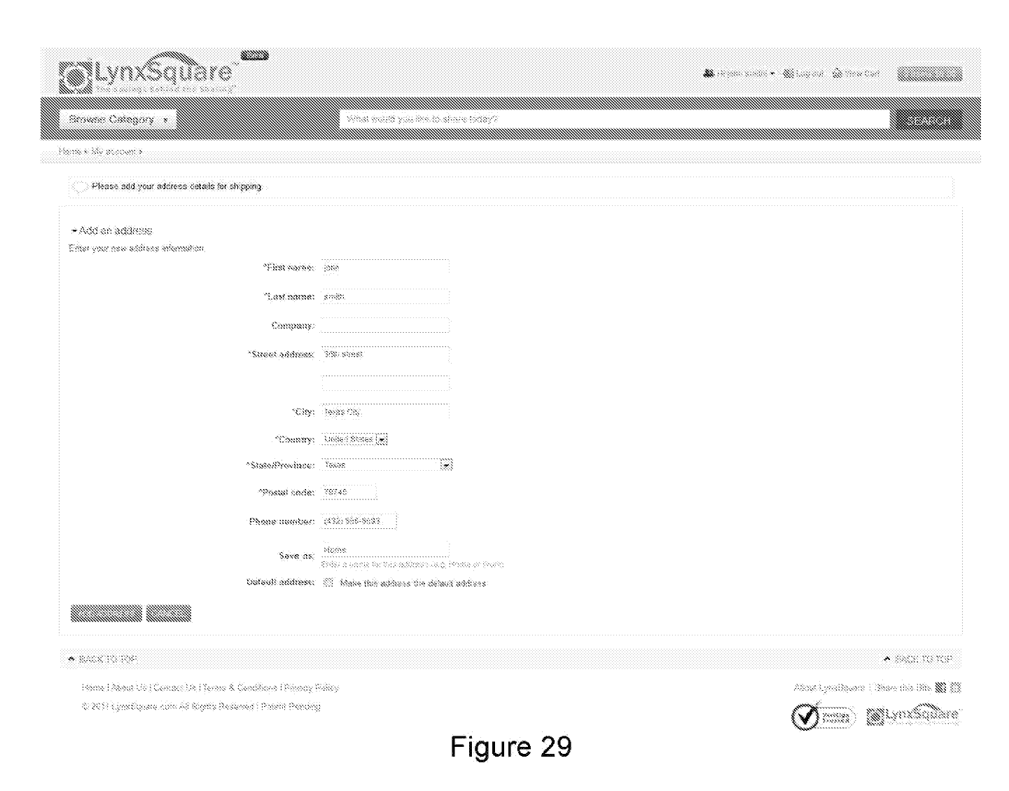

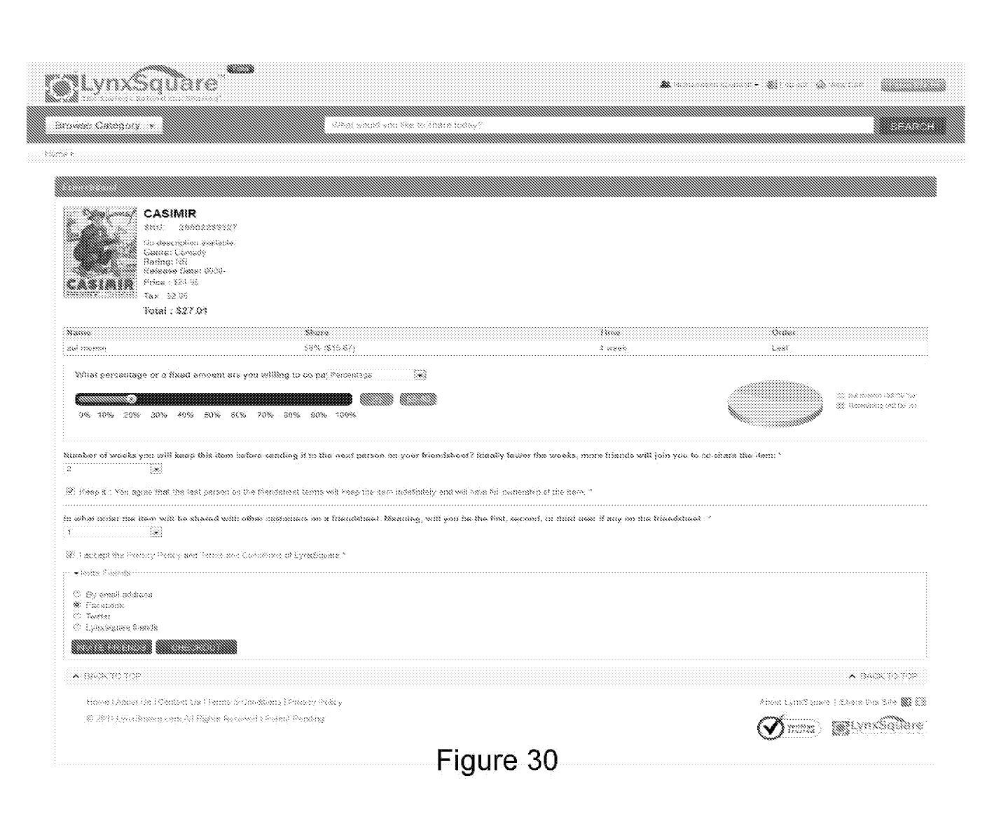

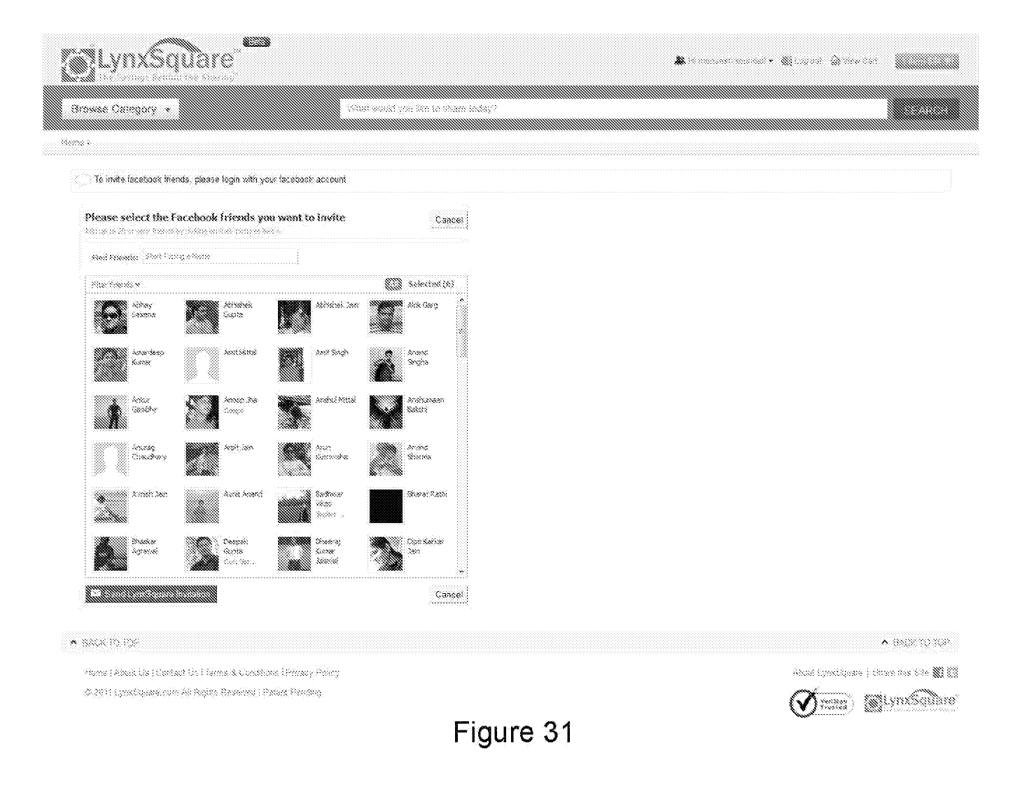

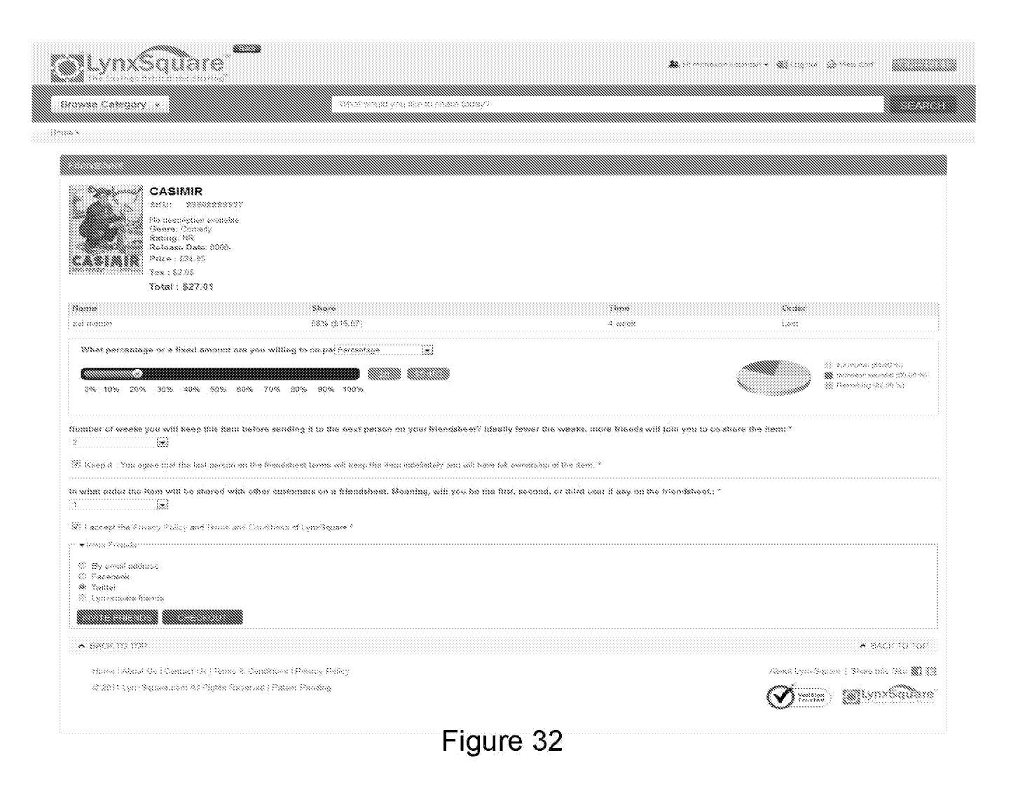

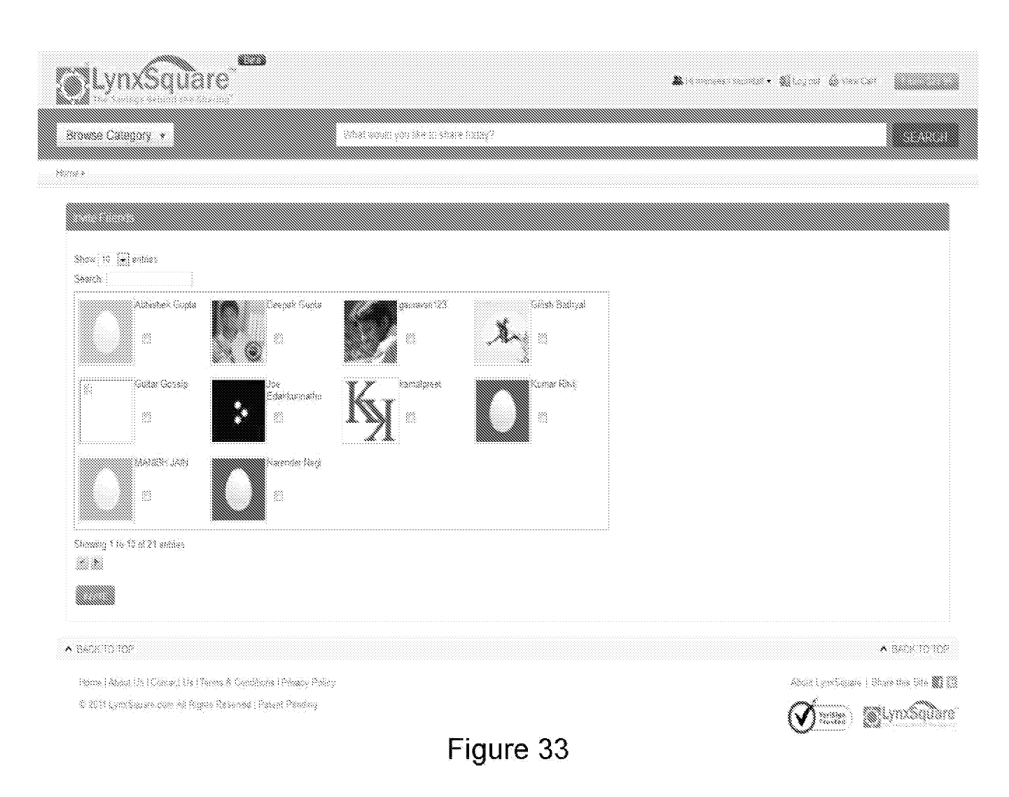

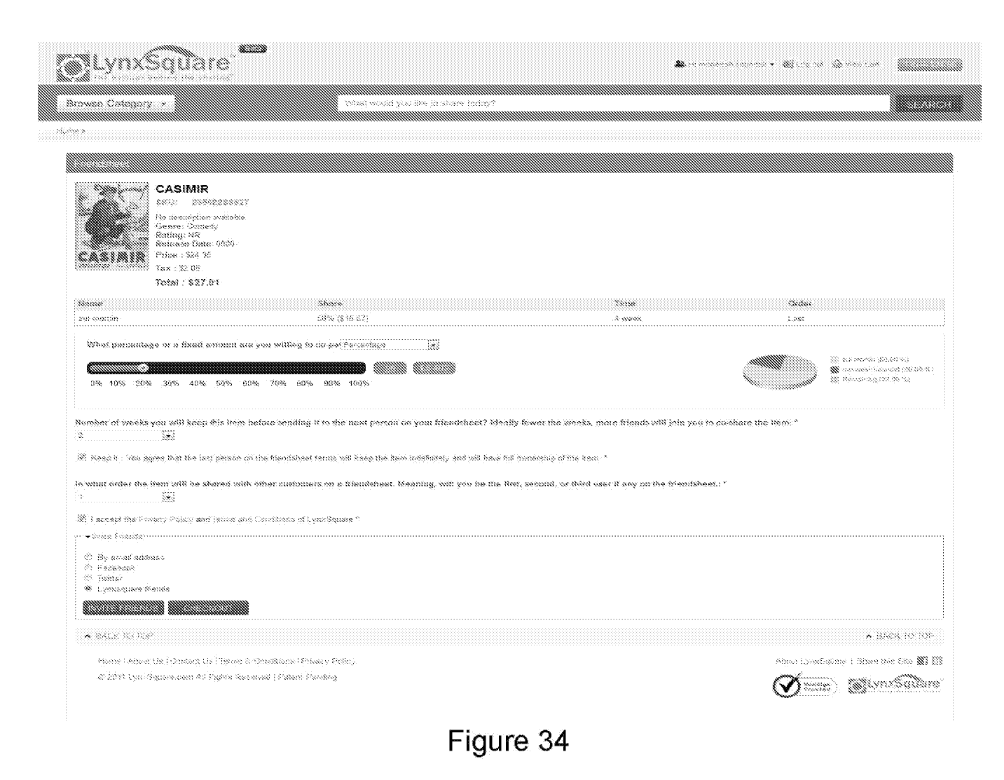

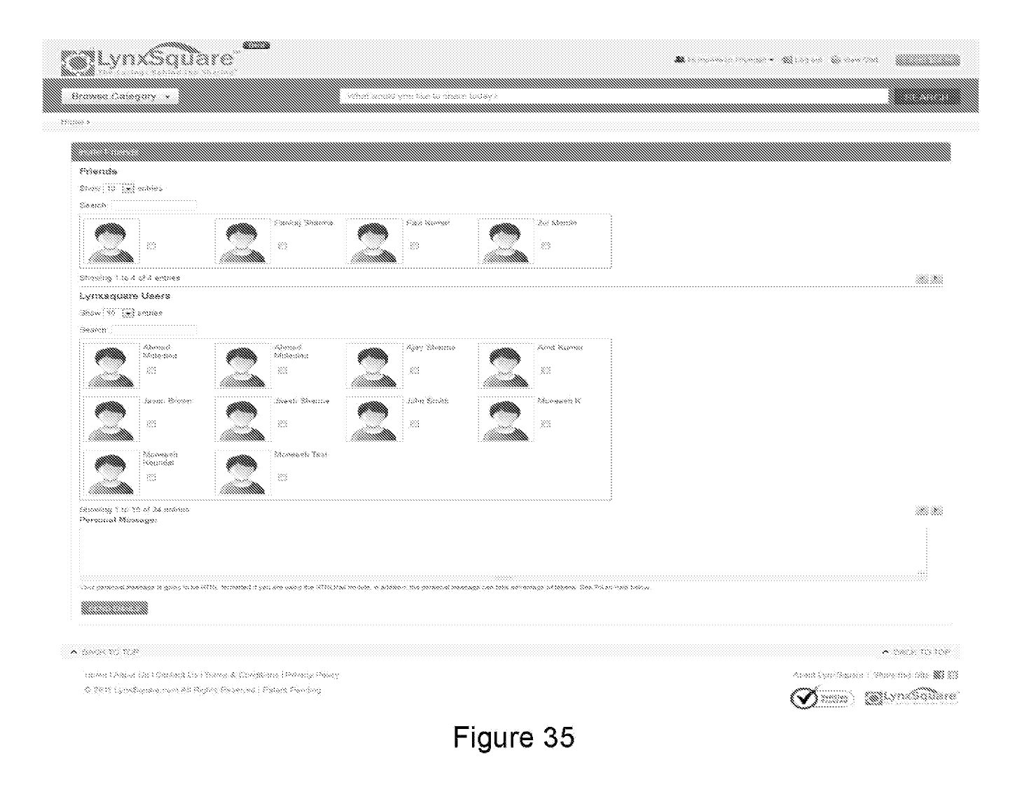

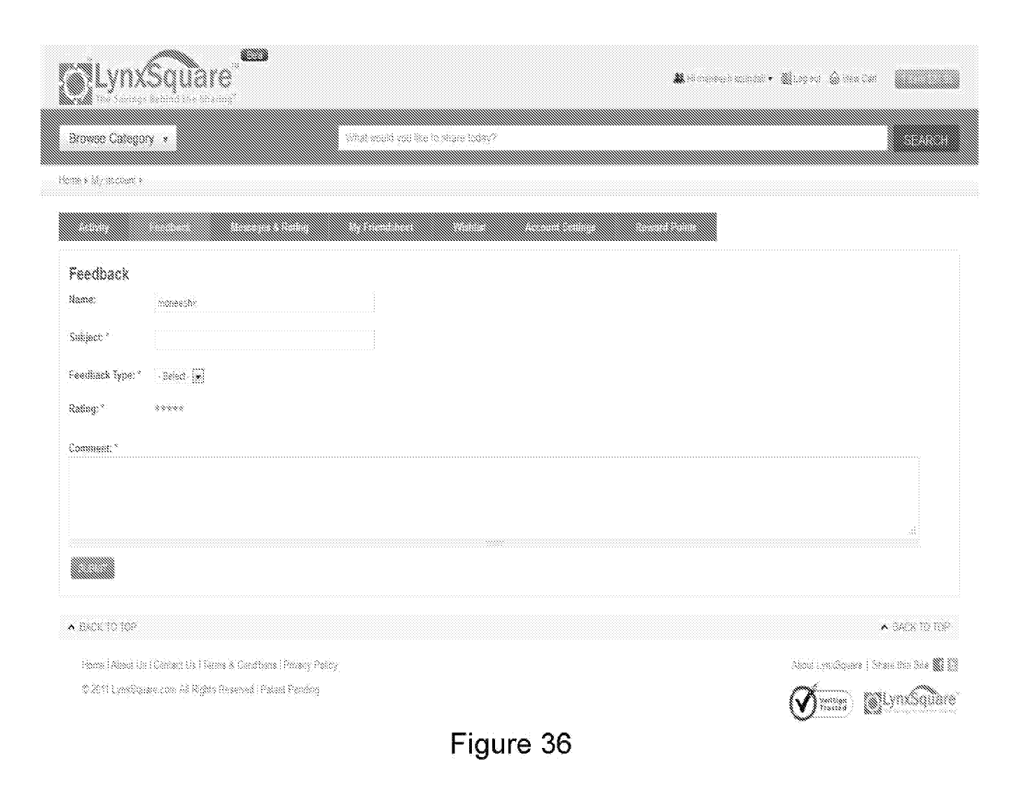

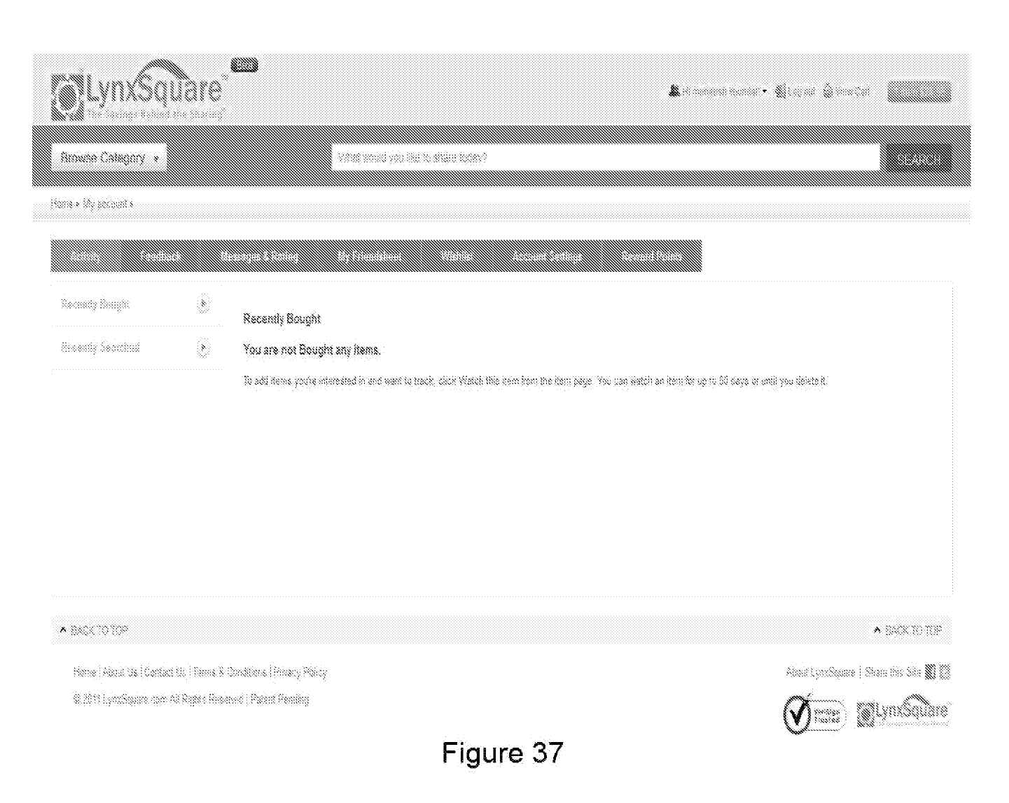

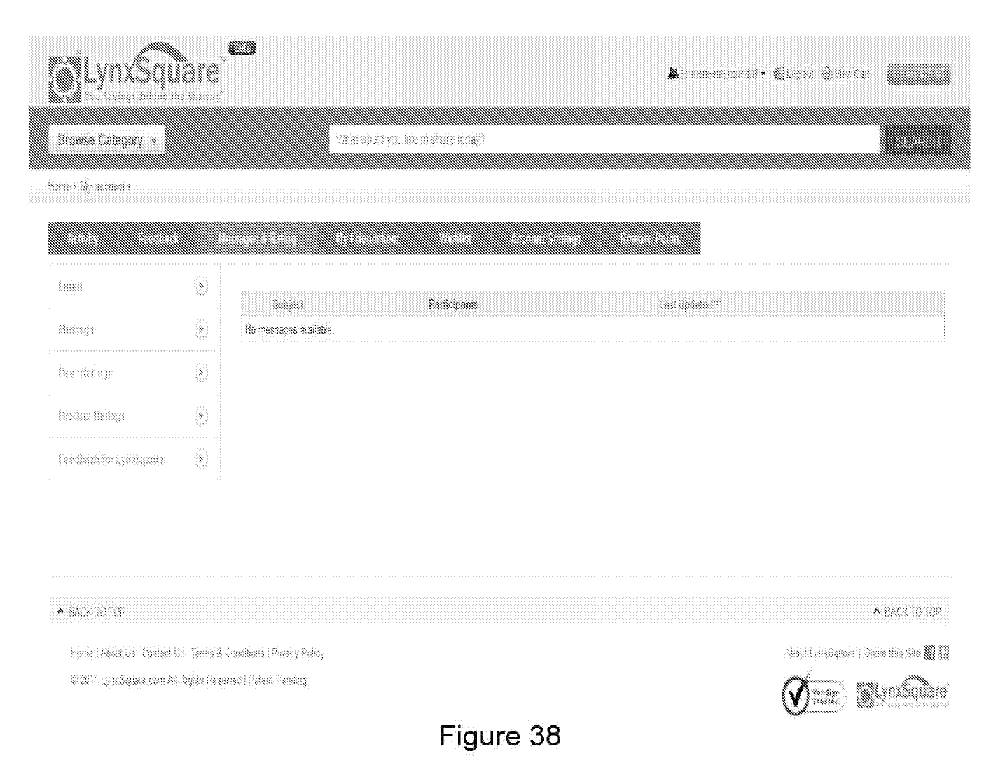

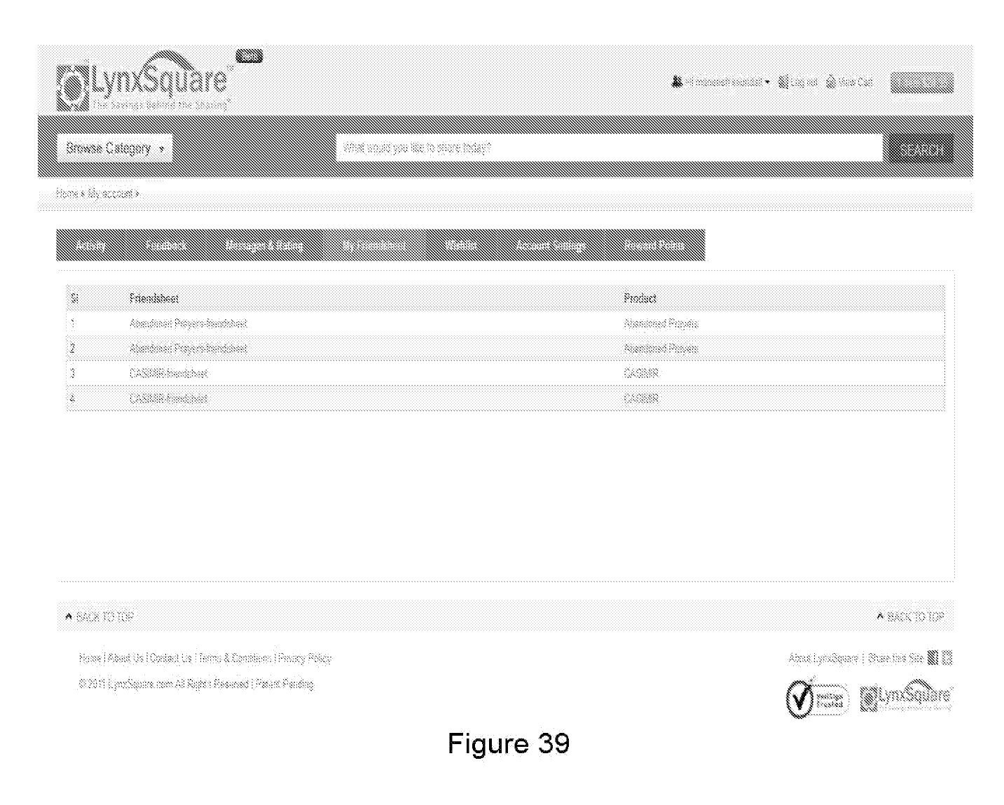

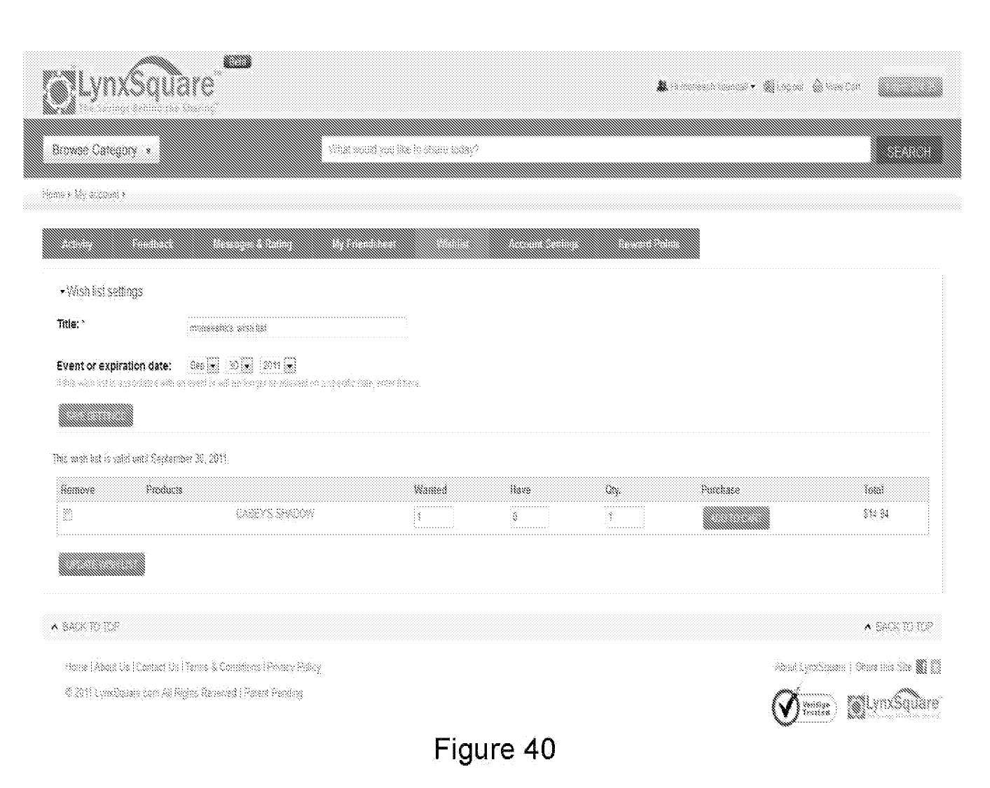

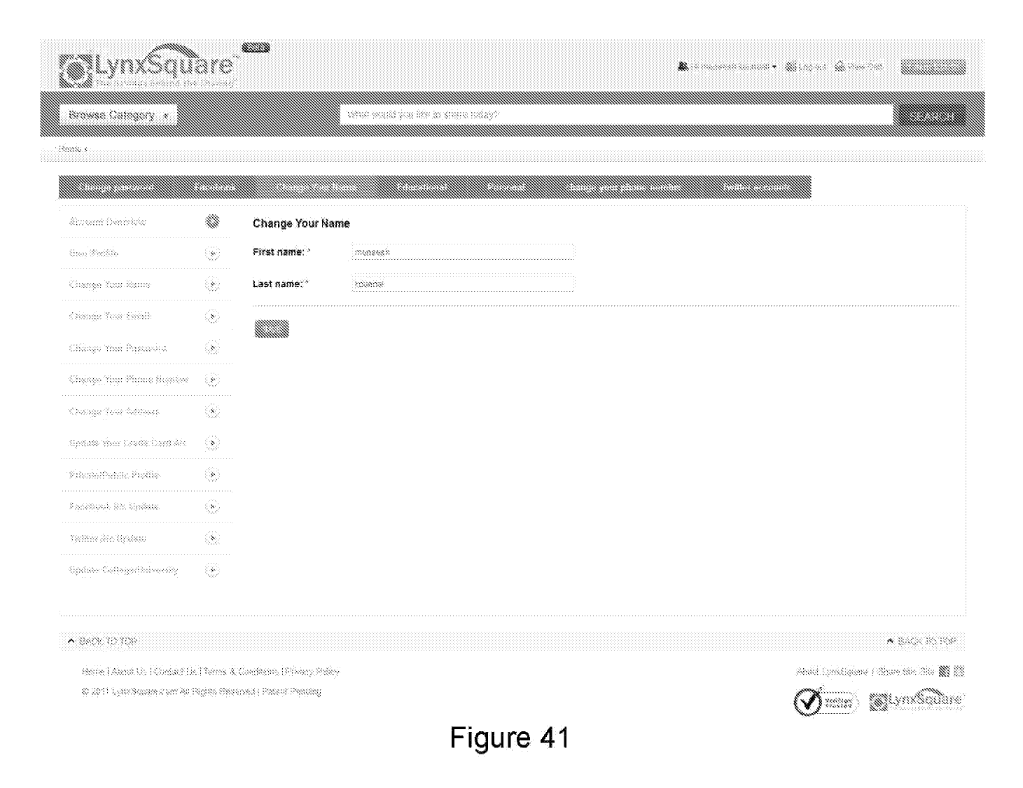

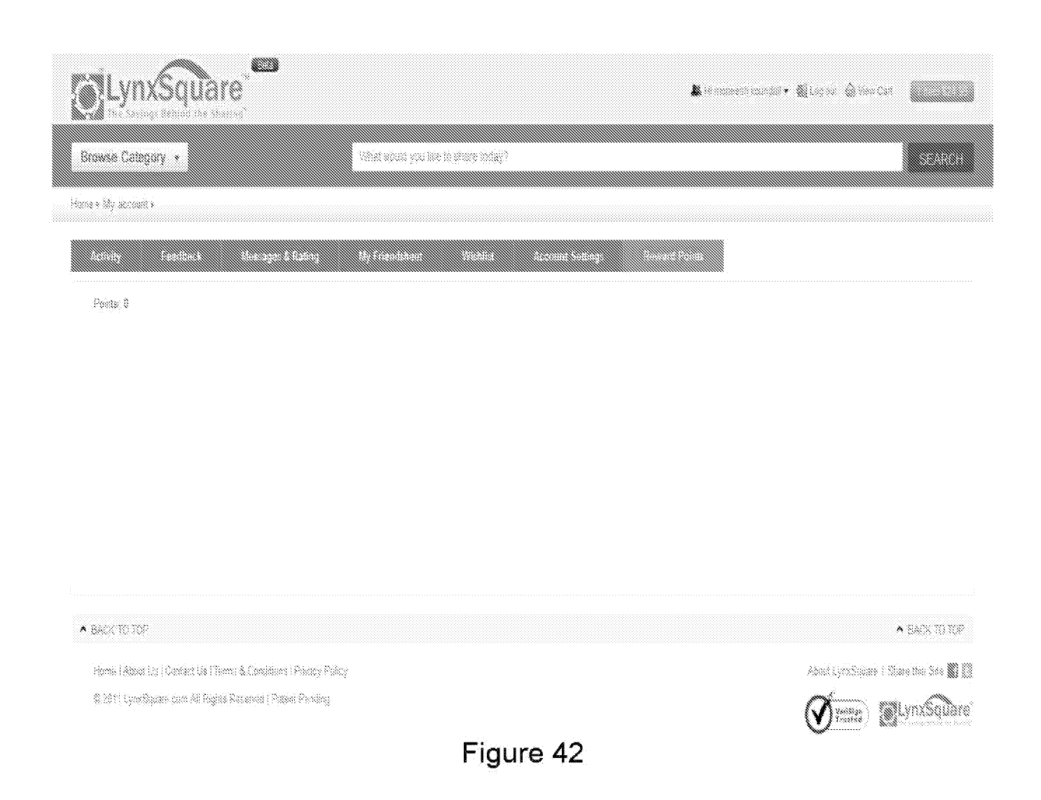

As perhaps best shown in FIGS. 4-42, a non-limiting exemplary embodiment(s) of the present disclosure advantageously may further include, a friend sheet module that can be employed to promote user collaboration and encourage group sharing/buying. The friend sheet module may provide a friend sheet form wherein a user can add his/her share percentage of both cost/use such that such percentages can be tracked and processed during checkout. In addition, the user may track his/her remaining time sharing period before transferring the item to a subsequent user or selling-back the item.

A user feedback module may be implemented on the e-commerce website to enable users to post feedback after receiving the item from the merchant or from a previous customer (i.e., co-sharing customer or reselling customer). This module gives a user the option to provide positive and/or negative feedback on the item's condition and general experience of using the item. A user activity module may be implemented to display recently purchased/used items, recently sold items, recently searched items. Such queries may be filtered by type of user, user location, user group, recently searched items by other users, etc. A profile user may be implemented to enable a user to change his/her profile. A product detail module may be implemented for creating an item detail page and adding features for friend reviews and rating.

A non-limiting exemplary embodiment(s) of the present disclosure may further include a PAYPAL® reference payment module that adds a PAYPAL® reference payment method in an UBERCART® e-commerce module and group checkout module. Using this feature, if a user has authorized his/her credit card, a previously assigned transaction key can be used for a new transaction and thereby obviate the need for the user to re-enter his/her credit card details during each subsequent transaction.

### Non-Limiting Exemplary Auto Post Module

As perhaps best shown in FIGS. 4-42, a non-limiting exemplary embodiment(s) of the present disclosure may advantageously further include an auto post module to permit the customer to sell back an item, in the friend sheet, after the customer has used the item for the agreed time period. In this manner, the item will be automatically listed on the e-commerce website again and, if a new customer buys the item, then the sale price of the item will be shared between the previous customer(s) who agreed to sell back the item. Such revenue sharing may be provided to the previous customer(s) based upon the same percentage in which such previous customer(s) initially co-paid for the item. Such percentages may be listed on the previous friend sheet for keeping track of revenue splitting (a sell price may manually entered by customer(s) or automatically calculated based on product usage time, market demand, etc.).

A non-limiting exemplary embodiment(s) of the present disclosure may further include a sales tax module for adding sales tax to the purchase price of registered users residing in Texas, USA, for example. Such users may be required to pay 8.25% sales tax. An invitation module may be implemented to add wish list users and friends in an email invitation that may be sent by a customer, merchant, and/or transaction host.

In a non-limiting exemplary embodiment(s) of the present disclosure, the UBERCART® e-commerce module is preferably developed for the DRUPAL® model structure, and is designed with the end user in mind, focusing on user-friendly applications in several key areas. For example, store configuration, product and catalog creation, and order administration. On a front-end of the e-commerce website, all major modules are configurable and integrate with the standard DRUPAL® modules (node, taxonomy, user, etc.). On a back-end of the e-commerce website, the settings pages and order administration pages may be designed to enable quick and efficient administrator changes.

The UBERCART® e-commerce module may be implemented to provide a configurable item catalog including catalog pages and a block to display item categories. A flexible item creation system with item classes may be displayed along with multiple item images. An item stock level tracking and notification module may be implemented along with item features to add file downloads, role promotions, and more to each item displayed on the e-commerce website. A single page checkout and automatic account generation (anonymous checkout) may be displayed on the e-commerce website. User and administrator checkout notifications as well as simple order processing (with workflow for automated order processing) may be displayed on the e-commerce website. In addition, simple order creation and editing with an integrated payment system that acts as a bridge between acceptable payment methods (check, credit card, purchase order, etc.) and payment gateways (CYBERSOURCE®, AUTHORIZE®.NET, PAYPAL®, etc.) may be displayed on the e-commerce website. In addition, sales, item, and customer reports with activity logging may be displayed on the e-commerce website.

A non-limiting exemplary embodiment(s) of the present disclosure may include shipping quotes and fulfillment orders, including integration with UPS®, FEDEX® and USPS®. For example, a shipping server may be included so that when an item is ordered from DOBA®, the shipping server provides the shipping tracking number for the item. The shipper's website can be accessed to track shipment and learn when the item is picked-up from an initial location and dropped at a final location. Such shipment tracking allows the transaction (service providers) host to track each customer's time period for using the item.

A non-limiting exemplary embodiment(s) of the present disclosure may further include a payment gateway that may be an e-commerce application service provider authorizing payments for e-businesses, online retailers, bricks and clicks, and/or traditional brick and mortar. Such a payment gateway may be an equivalent of a physical point of sale terminal located in conventional retail outlets. The payment gateway protects credit card details by encrypting sensitive information, such as credit card numbers, to ensure that information is passed securely between the customer and the merchant and also between merchant and the payment processor. As an example, PAYPAL® may be implemented for authorizing, receiving and capturing payment for the item. The UBERCART® e-commerce module is communicatively linked to the payment gateway, which is communicatively linked to PAYPAL®. The later communication link may be implemented via a CURL® extension in PHP to execute the PAYPAL® web service methods. Of course, other payment processing methodologies may be implemented without departing from the true scope and spirit of embodiment(s) of the present disclosure.

A non-limiting exemplary embodiment(s) of the present disclosure may further include a MYSQL® server (database) which is communicatively linked to the DRUPAL® core and contribute tables as well as custom module tables and the FACEBOOK® module. Such tables may contain user, cache, node, taxonomy, system, logging and variable tables etc. Custom tables may be created for group checkout, email notification, feedback, user time keeping status, DOBA® item detail, DOBA® order detail, invitation tables, etc. The communication links to and from the MYSQL® server may be via a PHP MYSQL® connection extension which gives access to read and write to MYSQL® server.

A non-limiting exemplary embodiment(s) of the present disclosure may further include an APACHE® SOLR search server, which may function as an enterprise search platform from the APACHE® Lucene project, well known in the industry. The SOLR server preferably includes powerful full-text search, hit highlighting, faceted search, dynamic clustering, database integration, rich document (e.g., Word, PDF) handling, and geospatial search. The SOLR search server is highly scalable, providing distributed search and index replication, and may power the search and navigation features of the e-commerce website.

The SOLR search server software may be written in Java and runs as a standalone full-text search server within a servlet container such as TOMCAT®. SOLR search server may use the Lucene JAVA® search library at its core for full-text indexing and search, and has REST-like HTTP/XML and JSON API that make it easy to use from virtually any programming language. SOLR search server's powerful external configuration allows it to be tailored to almost any type of application without Java coding, and it has extensive plug-in architecture when more advanced customization is required. For connecting DRUPAL® with APACHE® SOLR search server, the APACHE® SOLR module in DRUPAL® may be used, which give results for searched items.

A non-limiting exemplary embodiment(s) of the present disclosure may further include CRON™, which is a time-based job scheduler in Unix-like computer operating systems. CRON™ enables users to schedule jobs (commands or shell scripts) to run periodically at certain times or dates. It is used to automate system maintenance or administration, though its general-purpose nature allows it to be used for other purposes, such as connecting to the Internet and downloading email. CRON™ task is used for adding items from DOBA® server API preferably using SOAP web service in the DRUPAL® database. Also, CRON™ task may be used to send notifications and order status in the e-commerce website. Furthermore, background processes that need to be performed in e-commerce website may be completed by CRON™.

A non-limiting exemplary embodiment(s) of the present disclosure may further include the DOBA® server API, which is implemented to simplify and streamline item sourcing for users on the e-commerce website. The DOBA® API may provide drop shipping services and may further provide fraud protection for users.

A non-limiting exemplary embodiment(s) of the present disclosure may further include simple object access protocol (SOAP) web services for requesting item details and order details from the DOBA® server. In response, SOAP gives xml data which may be used to add item details and store order detail in the DRUPAL® database.

A non-limiting exemplary embodiment(s) of the present disclosure may further include a FACEBOOK® server such as FACEBOOK® connect API (FACEBOOK®—client library) for connecting with FACEBOOK® and getting results from FACEBOOK® for a customer(s) friend list, inviting FACEBOOK® users to join the friend sheet on the e-commerce website, as well as showing FACEBOOK® friends on the e-commerce website. For connecting with the FACEBOOK® server, a CURL® extension in PHP may be implemented, which requests data from FACEBOOK® for friends and invitations.

An activity feed plug-in may be implemented to display recent activity taking place on the e-commerce website. Because the content is hosted by FACEBOOK®, such a plug-in can display personalized content whether or not the user has logged into the e-commerce website. The activity feed plug-in preferably displays stories when users like content on the e-commerce website, when users share content from the e-commerce website in FACEBOOK® and/or if users comment on a page on the e-commerce website in a comments box. If a user is logged into FACEBOOK®, such a plug-in may be personalized to highlight content from their friends. If the user is logged out, the activity feed may show recommendations from the e-commerce website, and give the user the option to log into FACEBOOK®.

The activity feed plug-in may be filled with activity from the user's friends. If there is not enough friend activity to fill the plug-in, it may be backfilled with recommendations, for example. If a recommendations parameter is set to “true”, the plug-in may be split in half, showing friends activity in the top half, and recommendations in the bottom half, for example. If there is not enough friends' activity to fill half of the plug-in, the plug-in may include more recommendations. A specified domain may be identified to show activity from such a domain. The domain may be exactly matched, so a plug-in with <site=facebook.com> may not include activity from developers.

A non-limiting exemplary embodiment(s) of the present disclosure, one site may be selected; FACEBOOK®.com or www.FACEBOOK®.com. Aggregation across multiple domains may not be possible. The activity feed plug-in may be available either via an iframe that may be dropped into a page on the e-commerce website, or if new JavaScript SDK is used, the <fb:activity> XFBML tag may be implemented. Also, a deploy application may be implemented on FACEBOOK® for viral marketing of the e-commerce website in which the deploy application may open an iframe that may show an html page of the e-commerce website. When a user clicks on such an html page, he/she may be redirected to the e-commerce website.

A non-limiting exemplary embodiment(s) of the present disclosure may further include a TWITTER® server for inviting a TWITTER® user and sending TWITTER® messages on the TWITTER® server. A CURL® extension in PHP may be implemented to create a custom module and send a request on the TWITTER® server. As an option, a user may login to DRUPAL® his/her using TWITTER® username and password. A user may also send friend sheet invitations to TWITTER® users such that they will get notifications with a hyperlink pointing to the friend sheet on the e-commerce website. Thus, TWITTER® users can join the friend sheet and collaborate with other e-commerce website users to share an item's use/cost. The option for inviting the TWITTER® user to a friend sheet can be seen on the friend sheet page of the e-commerce website.

### Non-Limiting Example of Locating/Sharing an Item's Use/Cost Between Two Customers

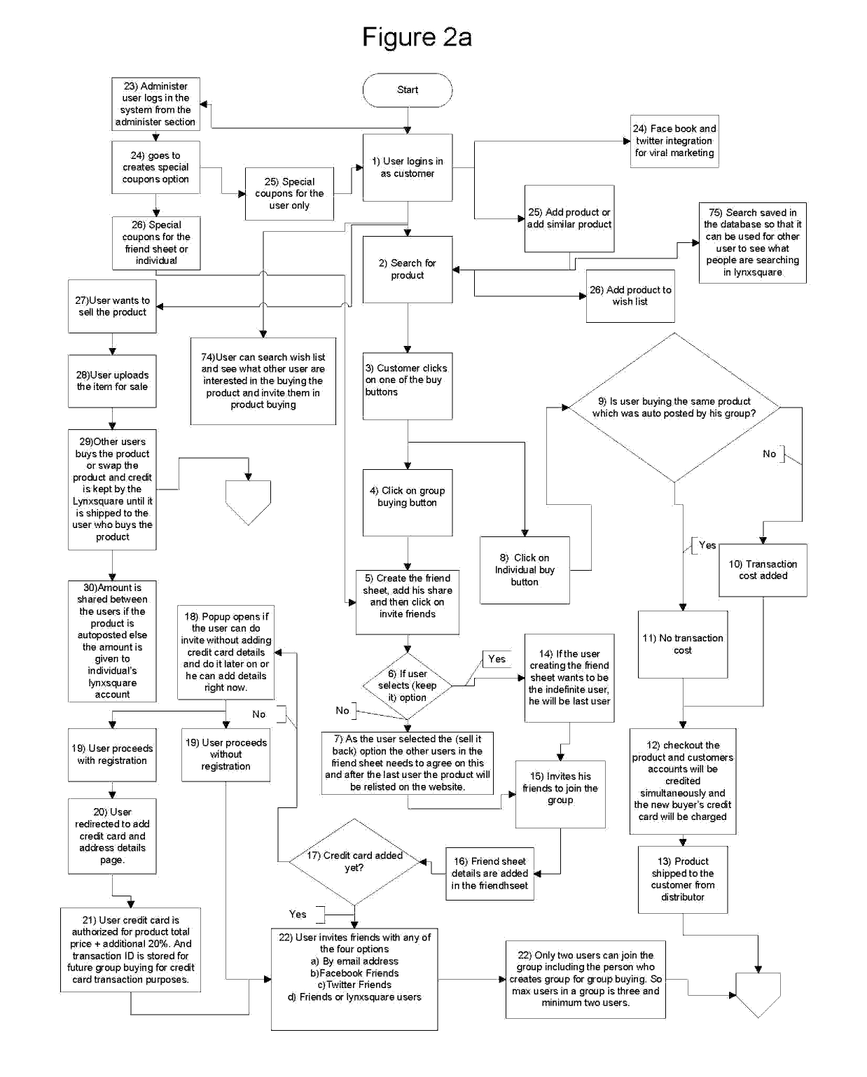

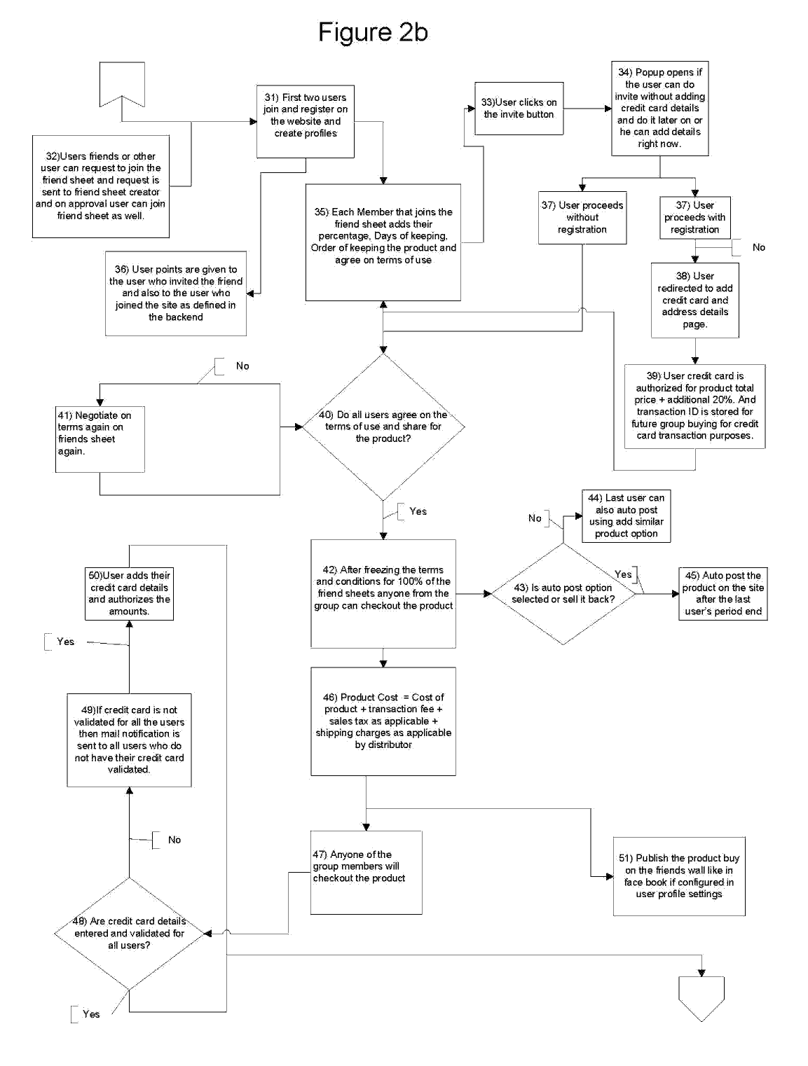

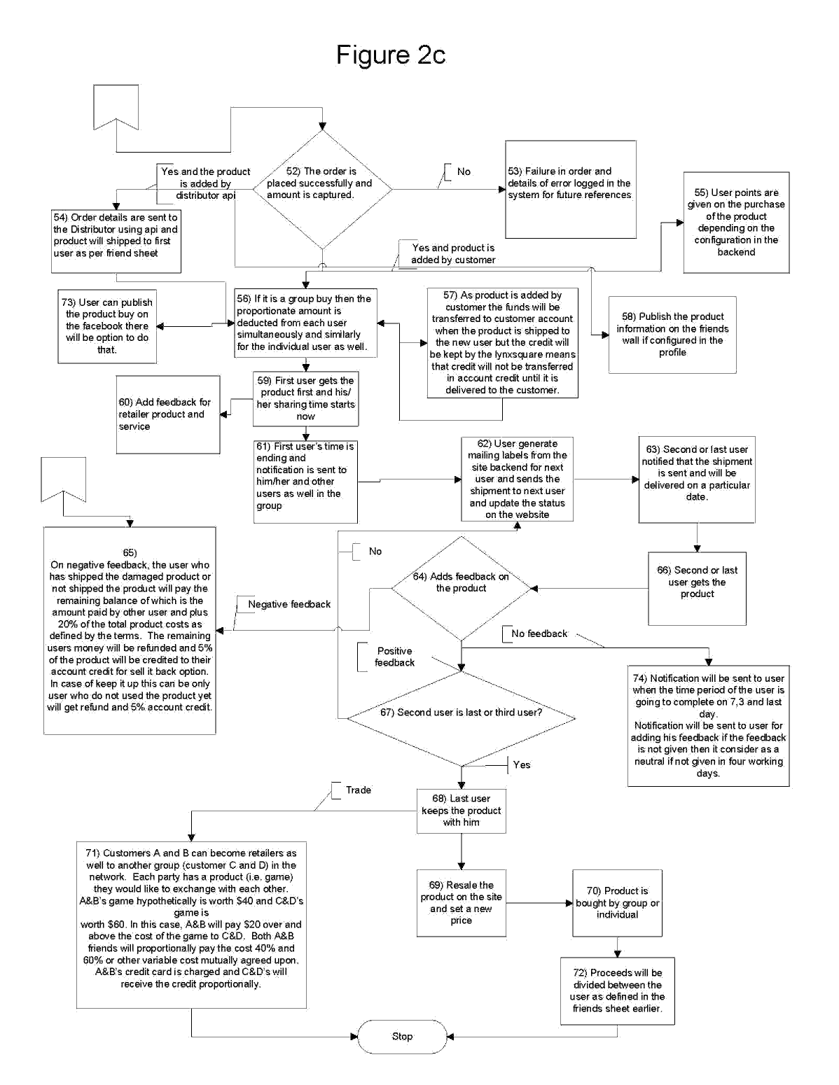

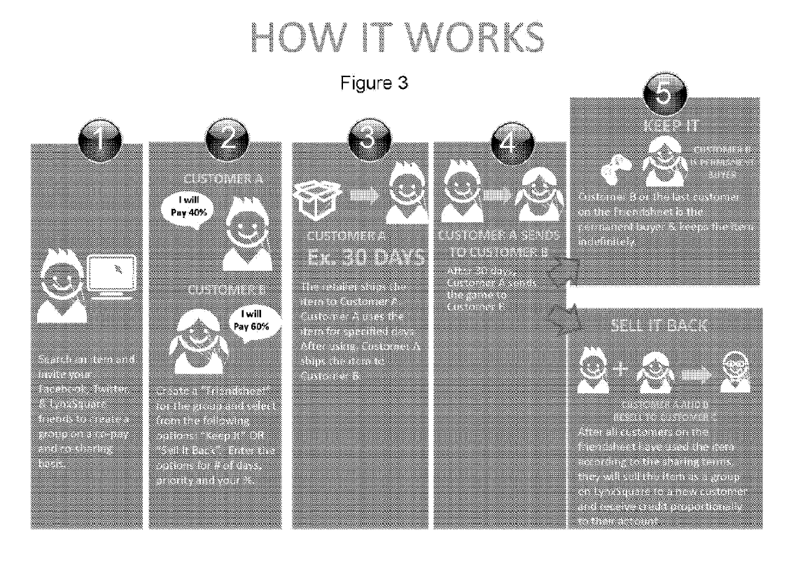

Collectively referring to FIGS. 2a-2c as well as FIGS. 3-42, a non-limiting exemplary embodiment(s) of the present disclosure's functionality may be explained as follows. Initially, a user (customer) may access a home page of the e-commerce website and login into the e-commerce website. Alternately, the user may simply view the home page of the e-commerce website without logging in. The user may search for a desired item (product/service) and may add search filters for querying the desired item from the database. An item listing may be shown and the user may select one of the items, which directs the user to an item detail page. The user may then see two options; for example, buying the item as a group buy and buying the item as an individual buy. If the user chooses the option for individual buy, he/she may not need to validate a credit card but if he/she chooses the option for the group buy he/she may be redirected to a create friend sheet page where he/she may see the created friend sheet for the item. The user may then join the friend sheet or he/she can create a new one.

The user may go to the created friend sheet page and add his/her share of the amount he/she wants to add to the item. For example, the user may bid or offer to pay a percentage of the asking price. Such an asking price may be fixed by the merchant or may be a variable asking price. The user may also select the sell-it-back option (item) or keep-it (item) option. The keep-it option may be defined as not automatically selling back the item after the last user's time period has expired. The user may further select the time period for using (keeping) the item as well as accept the terms and conditions for collaborating with another user, for example. After clicking submit, the user may continue with the process. It is noted that the user's credit card does not have to be pre-authorized. Thus, credit card validation may be an optional step in the initial phase of the collaboration process.

As an example, if the user selects the keep-it (item) option, then the user who creates the friend sheet may be the indefinite user which means the user intends to keep the item indefinitely. In this case, the user may be automatically listed as the last customer who keeps the item. As an option, the user may elect to sell back the item wherein the user can be listed as using the item in any order (either first, second . . . ) of all the customers. If the user confirms the order in which he/she uses the item, the user is permitted to keep the item for a maximum of time equal to the elected time period. As an example, if a first user confirms he/she is the first customer and agrees to use the item for a time period of four weeks for 60% of the purchase price, then a second user who joins the first user's friend sheet may keep the item a maximum of, for example, four weeks (in consideration for paying the remaining 40%) or any other agreeable term with the first user so long as the combined terms do not exceed a predetermined maximum term limit. The second user may pay the remaining balance or share the use of the item with a third user on the friend sheet. It is noted that co-pay share of a first, second and third user may not be proportional to such users' respective co-use items. In other words, if the second user pays less than the first user, the second user may be entitled to use the item for an equal time period as the first user so long as 100% of the item's purchase price is paid between the first and second user.

A non-limiting exemplary embodiment(s) of the present disclosure may further include an option for the user to participate in individual buying wherein the user may individually buy the item (no collaboration with another user). If a user tries to buy a same item that is auto posted by the user's group, then there may be no transaction cost applicable on the item. Thus, there may not be a transaction cost for the user buying the same item which is auto posted by his/her friend sheet. In other words, a transaction cost may be applicable if the user is buying a new item which is not auto posted by his/her friend sheet. A transaction cost may be configurable from a back-end of the e-commerce website and may vary for different items in different categories.

The user may checkout the item by adding his/her credit card details or may elect the PAYPAL® option to purchase the item. The user can add his/her shipping and billing address as well. Once the order is created in DOBA®, the item may be shipped to the first user per the shipping address given at the time of checkout.

If the user selects a group buy option, he/she may add his/her share and then submit the order, the transaction host (service provider) may check whether there is a pre-existing authorization ID for the user. Such a pre-existing authorization ID can be used to create a new transaction in PAYPAL®. If there is no pre-existing authorization ID, the transaction host may request the user to add his/her credit card details. For example, such credit card values may be submitted in the database and the user is asked whether he/she wants to register his/her credit now or later. As noted hereinabove, the DOBA® server provides an API to connect with retailers, distributors, etc. in real-time for maintaining the e-commerce website's inventory catalog up-to-date in real-time.

As a non-limiting example, the amount that may be authorized from the user account may be the item cost+X % of the item cost. Such a surcharge (or fee) may vary depending on the item type and may be adjusted by the transaction host. The X % may be captured by the transaction host at checkout. If the user adds wrong credit card information after the purchase amount is authorized, the transaction host may ask the user to reenter the correct credit card information. If incorrect credit card information is reentered, the account may not be validated and the user may be redirected back to the create friend sheet page. As an example, an authorized total amount from the user account may equal the (item cost)+(X % of the item cost)+(sales tax as applicable)+(transaction cost as applicable). Also, the transaction ID of the order may be stored in the database which may be later used for capturing the total amount at the time of checkout.

In a non-limiting exemplary embodiment(s) of the present disclosure, a first user may send an invitation to a second user to join the first user's friend sheet. The first user may invite the second user from the first user's FACEBOOK® friends list. Similarly, the first user may invite his/her TWITTER® friends to his/her e-commerce website friend sheet. Yet further, the first user may invite his/her friends from the e-commerce website. Different users can add each other to their friend sheets based upon selection of a common item in each user's wish list. A user may also send emails to other users by adding his/her friends' email addresses to join his/her friend sheet.

In a non-limiting exemplary embodiment(s), multiple online users may, in real-time, simultaneously negotiate sharing the purchase price, sharing use of the item and thereafter complete the checkout process for the item.

A non-limiting exemplary embodiment(s) of the present disclosure may limit the number of subsequent users that can join a first user's friend sheet. For example, there may be four options for inviting friends: a) a user can invite friend(s) by using their email address; b) a user can invite friends from FACEBOOK®; c) a user can invite friends from TWITTER®; and/or d) a user can invite registered friends and registered network users from the e-commerce website. As an example, the first user may limit the total number of users to three users (including the user who created the friend sheet; first user).

A non-limiting exemplary embodiment(s) of the present disclosure may provide coupons for users belonging to a common friend sheet on the e-commerce website. For example, an administrator of the e-commerce website may create coupons on a back-end of the e-commerce website that may be accessible by one, some and/or all users of the selected friend sheet. If one of the users creates a new friend sheet, then other user(s) of the friend sheet may be able to use the coupon. Alternately, a coupon may be designated for only an individual user so that the coupon is limited for use with only an individual buying transaction. An exemplary coupon(s) for an individual may provide a discount as a percentage of the purchase price or the exemplary coupon(s) may have a fixed value.

In a non-limiting exemplary embodiment(s) of the present disclosure, an exemplary sales module may operate as follows. A user may add similar product(s) existing on the e-commerce website or he/she can add new product(s) not existing on the e-commerce website or the user may auto post product(s) on the e-commerce website. As an example, the user can add product(s) from the profile page and add the details about the product as well. Another user can buy such a product(s) by creating a friend sheet or by individually buying the product(s). If the product(s) is auto posted, the amount paid for the product(s) will be shared between the user(s), per his/her friend sheet share parameters, or the user(s) can swap the product(s) with a group of buyers or an individual buyer. The user's credit card information may be kept with the e-commerce website database until the product(s) is shipped and received by the purchaser(s). The purchase price of the product(s) is shared if the product(s) was auto posted based on sharing parameters. The purchase price may be paid in full to an individual user, if it was posted as an individual seller (merchant).

In a non-limiting exemplary embodiment(s) of the present disclosure, if an initial user has an item listed for sale on the e-commerce website, a subsequent user can add the same item but the second user may need to obtain permission from the first user before adding the same item. When the subsequent user adds the same item, he/she can add the price of the item. For adding an item to the wish list, a user can go to the item description page where he/she will see the option of add to wish list.

In a non-limiting exemplary embodiment(s) of the present disclosure, the first two users who join a friend sheet are permitted to register and add their respective share of use/cost. If such users are not logged in, they cannot add their friend sheet shares of user/cost, respectively. Before adding their respective share of use/cost, each user may need to validate his/her credit card and authorize the payment for the item, which may equal the (item price)+(X % of cost of the item)+(sales tax as applicable)+(transaction cost as applicable). If the user's credit card is validated and payment is authorized, the offer (bid) of the share use/cost, which was added to the friend sheet, is submitted in the database and each user can see a checkout button in their e-commerce website account so long as the requisite item purchase price is collectively met by both users. If a user's credit card is not validated, then the user is redirected to the create friend sheet page. A user may add this friend sheet in his/her wish list so that he/she can see the friend sheet in his wish lists.

In a non-limiting exemplary embodiment(s) of the present disclosure, user points may be given to user(s) whose friends joined the e-commerce website. If all the users agree to the order of using the item, tracking their time period and their percentage of the item price that they have to pay, the collaborative transaction may be ready to checkout. If the user(s) do not agree on their share of use/cost of the item, the user(s) may continue to negotiate on the friend sheet or the user(s) may be permitted to send private messages to each other and thereby discuss their share of item use/cost as well as how each time period will be tracked. Thus, direct collaboration between user(s) is permissible on the e-commerce website.

In a non-limiting exemplary embodiment(s) of the present disclosure, when the terms of collaborative negotiations are approved by each user in the friend sheet, anyone of the user(s) can initiate the check out process for the item. Each user's option may be dependent on whether he/she chose the auto post (sell-it-back) option. If the auto post option was elected, then the item will be automatically listed on the e-commerce website for repurchase by subsequent users. The last user may be responsible for shipping the item to the subsequent user(s) who collaborated to repurchase the item. The shipping charges may be calculated in a similar manner by the DOBA® server API and credit card information may remain on the previous user's account until the new user receives the item. The repurchase price of the item may be less than the original purchase price of the item, depending on the total time period the previous users kept the item. A last user of the repurchase group can start a new repurchase cycle and automatically repost the item for yet another group of subsequent users to offer (bid) the shared use/cost of the item.

In a non-limiting exemplary embodiment(s) of the present disclosure, when any user clicks on the checkout link, their share of the item sale price may be charged to their account based on the agreed share percentage or fixed value of the item cost. Again, as an example, the total item price may equal to the (item cost)+(transaction fee as applicable)+(sales tax as applicable)+(shipping charges applicable) as listed by the distributor (merchant) via the DOBA® server API. In this manner, whenever a user desires to check out the item, an agreed upon percentage price may be captured from their account (charged to their credit card). After the item is bought, the transaction may be published in the merchant's and/or customers' FACEBOOK® wall if permitted by the users' profiles.

In a non-limiting exemplary embodiment(s) of the present disclosure, anyone of the users in the friend sheet can check out the product. An authorization ID may be created for all users in the friend sheet. If credit card information is not validated for all users, a notification is sent to all users who have not validated their credit card. After validation, the user may be redirected to the friend sheet page. The product can now be checked out. After buying the product, the product purchase may be published in a user's FACEBOOK® profile such as the user's FACEBOOK® wall. Of course, the user may configure their FACEBOOK® profile to permit the display of the product purchase or not. This option may be listed on the checkout page of the e-commerce website.

In a non-limiting exemplary embodiment(s) of the present disclosure, the transaction host (service provider) may determine whether the order (transaction) is successful and amounts successfully captured for all users. If anyone of the user's checkout process was not successful, that user must checkout again and the errors may be logged in a database for future references. If each user's checkout process is successful, then the order is created on the DOBA® server and payments may be funded to both the merchant's e-commerce website account as well as the transaction host's (service provider) account.

In a non-limiting exemplary embodiment(s) of the present disclosure, user points may be given to each user in group buying defined in the back-end administrator section of the e-commerce website. If the transaction is a group buy, then the shared cost of each user may be simultaneously deducted from the user's respective accounts. If the transaction is an individual buy, the total cost is deducted from the individual user's account. If an item is added by a user, not by the DOBA® server API, the funds may be transferred to the user's account when the item is shipped to the new user and such a new user confirms receipt of the item. The credit card information of both the previous and subsequent users may be kept by the e-commerce website in case there is a dispute as to who/when the item was damaged, for example.

After shipping the item, if the new (subsequent) user does not confirm receipt of the item within three working days (for example), the transaction host may assume the item was successfully shipped and received. At such time, the previous user's account is credited for having sold the item to the subsequent user. If the transaction is a collaborative group buy, each user of the group receives a proportionate credit to his/her account, which may be equal to each user's shared percentage of the item's sale price.

In a non-limiting exemplary embodiment(s) of the present disclosure, when a customer successfully buys an item, the transaction may be shown on the customer's new activity section of their user profile page. In this manner, the first user receives the item and his/her time period starts. The transaction host may then send periodic notifications to the first user, which notify him/her of the remaining time period. The first user can add feedback about the distributor (merchant) as well as the item. Such feedback may be stored by the transaction host for future references. Upon the end of the first time period, the transaction host may send a notification to the first user as well as the other users in the group. At such time, the first user may create mailing labels from the e-commerce website so that the product may be shipped to the next user in the group. Upon shipment, the e-commerce website (service provider) may update the transmission of the item to the next user.

The transaction host may then notify the second or last user that the item has been shipped to him/her. Such information may be displayed on the order page and the second user's time may start from the shipping date. If the second user does not confirm receipt of the item within five days of the shipping date (for example), the transaction host may consider the item was timely received and the second user time period starts. The second user may add feedback about the first user's handling and care of the item, which can be positive or negative. If a negative feedback is posted, the (item cost that is paid by the other users in the group)+(X % of the cost of item) may be deducted from the first user's account that shipped the item. If the second user is the last user, he/she may indefinitely keep the item or resell the item at a later date.

If the second user is not the last user, then he/she may ship the item to a third user after the second user's time period expires. The third user may keep the item if the keep-it option was elected. Otherwise, the transaction host may automatically repost the item for resale at the end of the third time period. Such a resale may have a price that is predefined by the last user.

In a non-limiting exemplary embodiment(s) of the present disclosure, if the item is purchased by a subsequent group (or individual) the resale price may be credited to the last user's account or last user group's account when the last user ships the item and the subsequent user confirms receipt of the item. Of course, an item that is auto posted or added by the owner of the item can be shared by a group of users or can be bought by an individual user. For example, customers A and B (group 1) may become merchants by reselling the item to a subsequent user group including customers C and D (second group).

In another example, both group 1 and group 2 may have an item (i.e. game) they would like to exchange with each other. Group 1's game may be worth $40 and group 2's game may be worth $60. In this case, group 1 may pay $20 over and above the cost of group 1's game to customers C and D. Customers A and B may proportionally pay 40% and 60% of the cost of group 2's game (or other variable cost mutually agreed upon). Customer A's and B's credit card may be charged and customers C and D may receive the credit proportionally to their account. Use of the items may be shared between customers A and B as well as customers C and D, as previously defined in each group's friend sheet. Each customer of each group may subsequently receive a percentage credit to their account when the items are resold to new user(s) who confirm receipt of the items and provide positive feedback.

There are many applicable usage and possibilities of exemplary embodiment(s) of the present disclosure such as video games, books, e-books, e-games, electronic files containing desirable data such as music, CD's, etc. Additionally, the multiple buyer co-purchasing and co-sharing concept could be applicable when a customer purchases time sharing condos/vacation home, or buying prepaid phone card, leasing vehicles, booking hotel rooms, etc.

In a non-limiting exemplary embodiment(s), the system may include an automated feature. Such an automated feature may be executed in several steps where multiple customers (especially friends) can pre-authorize each other to make purchases or sell on their behalf by pre-authorizing a dollar amount or a one-time authorization (of registered credit card for purchase only) to make a purchase of a product (video game) collectively. This occurs when both customers are not simultaneously online and one person finds a good deal and wants to act immediately by collectively purchasing a product with a friend by co-sharing and co-paying for the product cost. In this way, the system may allow one customer to act alone without another customer's simultaneous online presence to automatically make the purchase decision while splitting the cost between two customers credit card at the point of sale.

As a non-limiting example, when two customers are bidding or negotiating a price and when the price reaches the final sale price (say $100), which may be a variable or fixed price mutually agreed by two customers, then it may be binding and final on both parties. Cash credit may be actual cash, refund or points/rewards holding the same financial value as cash, which may accumulate in customers' accounts to be redeemed for future purchases. Various payment methods may be employed such as the use of: credit cards, checking accounts (ACH), debit cards, prepaid accounts (gift cards) or other well known financial instruments.

### Non-Limiting Example of Real-Time Online Bidding Between Customers

As perhaps best shown in FIGS. 4-22, in a non-limiting exemplary embodiment, a real-time online bidding may permit multiple bidders to pool bids during a bidding session. The bidding may be conducted over a computer network that includes a central computer (host server), a number of remote computers (customers), and a communications network (Internet) connecting the remote computers to the central computer. A number of bidders may be registered at an e-commerce website hosted by the central computer. Each bidder may enter/reenter their co-pay amount, and co-share time on a friend sheet or bid session. A person creating the friend sheet or bidding session may control who to collaborate with on co-pay and co-share basis. For example, if there are 10 different bidders with different co-pay amounts and different co-share times, the person initiating a bidding session or friend sheet may select the best possible economical bid for himself/herself as well as the other bidders.

In a non-limiting exemplary embodiment(s), the e-commerce website may be a peer-to-peer, online, collaborative, group-buying, social market place where customers co-pay and co-share items, thereby saving money on the cost of purchasing products/services (whether in electronic or physical format).

In a non-limiting exemplary embodiment(s), a user may login as a registered user. For example, a user may log in with a TWITTER® account or a FACEBOOK® account. In this manner, the e-commerce website may provide the integration point. As an option, a user may be able to view TWITTER® and FACEBOOK® feeds for the e-commerce website's registered users that are tweeting or otherwise talking about either the e-commerce website or about items (such as products/services) offered for sale on the e-commerce website. Featured items may be listed on a page of the e-commerce website wherein the user can directly check out from the screen page as an “Add To Cart” or a “Group Buy” item. The user can also view items in a catalogue displayed on the e-commerce website.

After the user conducts a search for a desired item, the search results may be displayed on the e-commerce website. A search can be performed by price, item type, etc. Specific information about the desired item may be displayed on the e-commerce website.

Information about other users who viewed and/or bought the desired item or similar items may also be displayed. The e-commerce website may also show item reviews. A user can write his/her item review as well. A user can click on icons and give it a rating and the user can see his/her friends' reviews as well.

As an example, a user may click on individual buying option, which initiates an e-commerce check out process. Advantageously, a user may click on a group buying option that preferably provides a plurality of choices. The user may either create a friends sheet, or if there are existing friend sheets that have a possibility of joining into the group buy option, the user may initiate that process. In this example, it may be assumed that there are no existing friend sheets. If existing friend sheets are full, the user may create a new friend sheet. A friend sheet negotiates the terms between friends in the buying group. One term may be the percentage of the item's purchase price that each friend will pay. The other term may be who gets to use the product first, and second. In other words, the friend sheet may identify the priority of use between each user in the group buying option. A third term may be how many weeks each user will keep (use) the purchased item.

At this point, the user may select their values for such terms. As an example, a user may select sixty percent of the purchase price for the item wherein the user states he/she is going to keep (use) the item for four weeks. Such a “use” option may allow the friend sheet creator to be either the first user, intermediate user or the last user for his/her respective term. If it is at the end of all the users' terms, the last user may sell back the item (sell-it-back) or keep the item (keep-it) based on the previous selection made on the friend sheet.

Next, the user can invite his/her friends to the friend sheet by communicating via e-mail, FACEBOOK®, or TWITTER®, for example. A user may see his/her list of friends that are already on the friend list. By selecting the desired friend on the friend list, the user may communicate via the friend and invite the friend to the friend sheet for the desired item.

After the request has been sent, the website may show sixty percent of the item's purchase price has been covered by the user and forty percent is remaining. When another user (second user) logs into the e-commerce website, he/she can conduct a similar search for the desired item. After selecting the desired item, the second user may go to the same filter containing the desired item. Here, the second user may see the same options for individual or group buying. After selecting group buying, the second user may either create a new friend sheet with a different user, or the second user can join the first user's friend sheet.

The second user may select his/her percentage of the item's purchase price at forty percent because that is what's remaining. Alternately, the second user may select a lesser value. The second user may further select the number of weeks he/she will keep (use) the item. In this example, it may be also four weeks. The second user may also agree to sell back the item when he/she is done using the item. The second user may further select the order he/she wants to keep the item. In this example, it is second (after the first user). Now, the second user may accept his selections and then click on the “invite friends” option. Therefore, if any remaining percentage of the item's purchase price exists from one-hundred percent, then the second user can invite a third user to join the friend sheet for the desired item. In this example, the full purchase price of the item is covered by the first and second users. Therefore, the item is ready to be shipped after check out.

After checkout, the item is ordered in the back-end of the e-commerce website and it is shipped to the first user in the queue of the friend sheet. During checkout, the first and second user's credit cards are simultaneously charged.

Referring now to the user profile screens, each user can view his/her wish list, friend sheets, friends, reminders, etc. Such features help each user track his/her desired item and time remaining for using the desired item.

Referring to the figures in general, an e-commerce computer system may include a computing device, a computer software program stored in non-transitory computer readable memory, that when executed by the computing device, is configured to perform operations including: locating and displaying an item offered for sale by a merchant; displaying a sale price of the item wherein use of the item as well as the sale price of the item is shared between first and second customers; displaying a first bid, associated with the first customer, to use the item for a first period of time wherein the first bid is equal to a first fraction of the sale price; and displaying a second bid, associated with the second customer, to use the item for a second period of time wherein the second bid is equal to a second fraction of the sale price. In this manner, the first and second customers are authorized to use the item for the first and second periods of time upon paying to the merchant the first and second fractions of the sale price respectively.

In a non-limiting exemplary embodiment, the first and second customers may simultaneously pay to the merchant the first and second fractions of the sale price.

In a non-limiting exemplary embodiment, a sum of the first and second bids may equal the sale price.

In a non-limiting exemplary embodiment, the item may include a product.

In a non-limiting exemplary embodiment, the product may be a physical product.

In a non-limiting exemplary embodiment, the product may be contained in an electronic format and thereby electronically shared between the first and second customers.

In a non-limiting exemplary embodiment, the item may be a service to be provided by the merchant.

In a non-limiting exemplary embodiment, at least one of the first and second customers may be an individual.

In a non-limiting exemplary embodiment, at least one of the first and second customers may be a group of individuals.

Referring to the figures in general, a computer implemented method preferably includes: locating and displaying an item offered for sale by a merchant; displaying a sale price of the item wherein ownership of the item as well as the sale price of the item is shared between first and second customers; displaying a first bid, associated with the first customer, to use the item for a first period of time wherein the first bid is equal to a first fraction of the sale price; and displaying a second bid, associated with the second customer, to use the item for a second period of time wherein the second bid is equal to a second fraction of the sale price. In this manner, the first and second customers are authorized to use the item for the first and second periods of time upon paying to the merchant the first and second fractions of the sale price respectively.

In a non-limiting exemplary embodiment, a computer program may be embodied on a computer readable storage medium for enabling first and second customers to share a use and a purchase price of an item. Such a computer program preferably includes the steps of: locating and displaying an item offered for sale by a merchant; displaying a sale price of the item wherein ownership of the item as well as the sale price of the item is shared between first and second customers; displaying a first bid, associated with the first customer, to use the item for a first period of time wherein the first bid is equal to a first fraction of the sale price; and displaying a second bid, associated with the second customer, to use the item for a second period of time wherein the second bid is equal to a second fraction of the sale price. In this manner, first and second customers are authorized to use the item for the first and second periods of time upon paying to the merchant the first and second fractions of the sale price respectively.

It will be appreciated, that many applications of the exemplary embodiment(s) of the present disclosure could be formulated. One skilled in the art will appreciate that the networks may include any system for exchanging data or transacting business, such as the Internet, an intranet, an extranet, WAN, LAN, satellite communications, and/or the like. It is noted that the networks may be implemented as other types of networks, such as an interactive television (ITV) network. The users may interact with the system via any input device such as a keyboard, mouse, kiosk, personal digital assistant, handheld computer (e.g., PALM PILOT®), cellular phone and/or the like. Similarly, exemplary embodiment(s) of the present disclosure could be used in conjunction with any type of personal computer, network computer, workstation, minicomputer, mainframe, or the like running any operating system such as any version of WINDOWS®, WINDOWS NT®, WINDOWS2000®, WINDOWS 98®, WIDOWS 95®, MACOS®, OS/2, BeOS, LINUT®, UNIX®, or the like. Moreover, although exemplary embodiment(s) of the present disclosure may be implemented with TCP/IP communications protocols, it will be readily understood that exemplary embodiment(s) of the present disclosure could also be implemented using IPX, APPLETALK®, IP-6, NetBIOS, OSI or any number of existing or future protocols. Moreover, the system contemplates the use, sale or distribution of any goods, services or information over any network having similar functionality described herein.

As will be appreciated by one of ordinary skill in the art, the exemplary embodiment(s) of the present disclosure may be embodied as a method, an e-commerce data processing system, a device for e-commerce data processing, and/or a computer program product. Accordingly, the exemplary embodiment(s) of the present disclosure may take the form of an entirely software embodiment, an entirely hardware embodiment, or an embodiment combining aspects of both software and hardware. Furthermore, the exemplary embodiment(s) of the present disclosure may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

It should be appreciated that the particular implementations shown and described herein are illustrative of exemplary embodiment(s) of the present disclosure and its best mode and are not intended to otherwise limit the scope of the exemplary embodiment(s) of the present disclosure in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

Communication between the parties to the transaction and the system of the exemplary embodiment(s) of the present disclosure is accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the exemplary embodiment(s) of the present disclosure may include any combination of databases or components at a single location or at multiple locations, wherein each database or system includes any of various suitable security features, such as firewalls, access codes, encryption, de-encryption, compression, decompression, and/or the like.

The exemplary embodiment(s) of the present disclosure is described herein with reference to screen shots, block diagrams and flowchart illustrations of methods, apparatus (e.g., systems), and computer program products according to various aspects of exemplary embodiment(s) of the present disclosure. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus that provides steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In the foregoing specification, exemplary embodiment(s) of the present disclosure has been described with reference to specific embodiments. However, it will be appreciated that various modifications and changes can be made without departing from the scope of the exemplary embodiment(s) of the present disclosure as set forth in the claims below. The specification and figures are to be regarded in an illustrative manner, rather than a restrictive one, and all such modifications are intended to be included within the scope of exemplary embodiment(s) of the present disclosure. Accordingly, the scope of exemplary embodiment(s) of the present disclosure should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of exemplary embodiment(s) of the present disclosure unless expressly described as “essential” or “critical”.

What is claimed as new and what is desired to secure by Letters Patent of the United States is:

1. An e-commerce computer system, comprising:
a computing device;
a computer software program stored in non-transitory computer readable memory, that when executed by the computing device, is configured to perform operations comprising:
locating and displaying an item offered for sale by a merchant;
displaying a sale price of said item wherein use of said item as well as said sale price of said item is shared between first and second customers;
displaying a first bid, associated with the first customer, to use said item for a first period of time wherein said first bid is equal to a first fraction of said sale price; and
displaying a second bid, associated with the second customer, to use said item for a second period of time wherein said second bid is equal to a second fraction of said sale price;
wherein the first and second customers are authorized to use said item for said first and second periods of time upon paying to the merchant said first and second fractions of said sale price respectively.

2. The e-commerce computer system of claim 1, wherein said first and second customers simultaneously pay to said merchant said first and second fractions of said sale price.

3. The e-commerce computer system of claim 1, wherein a sum of said first and second bids equals said sale price.

4. The e-commerce computer system of claim 1, wherein said item comprises: a product.

5. The e-commerce computer system of claim 4, wherein said product is a physical product.

6. The e-commerce computer system of claim 4, wherein said product is contained in an electronic format and thereby electronically shared between the first and second customers.

7. The e-commerce computer system of claim 1, wherein said item is a service to be provided by the merchant.

8. The e-commerce computer system of claim 1, wherein at least one of said first and second customers is an individual.

9. The e-commerce computer system of claim 1, wherein at least one of said first and second customers is a group of individuals.

10. A computer implemented method, comprising:
locating and displaying an item offered for sale by a merchant;
displaying a sale price of said item wherein ownership of said item as well as said sale price of said item is shared between first and second customers;
displaying a first bid, associated with the first customer, to use said item for a first period of time wherein said first bid is equal to a first fraction of said sale price; and
displaying a second bid, associated with the second customer, to use said item for a second period of time wherein said second bid is equal to a second fraction of said sale price;
wherein the first and second customers are authorized to use said item for said first and second periods of time upon paying to the merchant said first and second fractions of said sale price respectively.

11. The computer implemented method of claim 1, wherein said item is displayed on an e-commerce website.

12. The computer implemented method of claim 10, wherein said first and second customers simultaneously pay to said merchant said first and second fractions of said sale price.

13. The e-commerce computer system of claim 10, wherein a sum of said first and second bids equals said sale price.

14. The computer implemented method of claim 10, wherein said item comprises: a product.

15. The computer implemented method of claim 14, wherein said product is a physical product.

16. The computer implemented method of claim 14, wherein said product is contained in an electronic format and thereby electronically shared between the first and second customers.

17. The computer implemented method of claim 14, wherein said item is a service to be provided by the merchant.

18. The computer implemented method of claim 14, wherein at least one of said first and second customers is a group of individuals.

19. A computer program, embodied on a computer readable storage medium, for enabling first and second customers to share a use and a purchase price of an item, said computer program comprising the steps of:
locating and displaying an item offered for sale by a merchant;
displaying a sale price of said item wherein ownership of said item as well as said sale price of said item is shared between first and second customers;
displaying a first bid, associated with the first customer, to use said item for a first period of time wherein said first bid is equal to a first fraction of said sale price; and
displaying a second bid, associated with the second customer, to use said item for a second period of time wherein said second bid is equal to a second fraction of said sale price;
wherein the first and second customers are authorized to use said item for said first and second periods of time upon paying to the merchant said first and second fractions of said sale price respectively.

20. The computer program product of claim 19, wherein said first and second customers simultaneously pay to said merchant said first and second fractions of said sale price.

21. The computer program product of claim 19, wherein a sum of said first and second bids equals said sale price.

22. The computer program product of claim 19, wherein said item comprises: a product.

23. The computer program product of claim 19, wherein said product is a physical product.

24. The computer program product of claim 19, wherein said product is contained in an electronic format and thereby electronically shared between the first and second customers.

25. The computer program product of claim 19, wherein said item is a service to be provided by the merchant.

26. The computer program product of claim 19, wherein at least one of said first and second customers is a group of individuals.
